(19) United States
(12) Patent Application Publication
(10) Pub. No.: US 2009/0006968 A1
(43) Pub. Date: Jan. 1, 2009

(54) System, computer-implemented method, and removable computer-readable medium with software for creating and displaying dynamically and automatically in real time a transient themed digital multimedia slide show presentation

(76) Inventor: Keoki Trask, Sarasota, FL (US)

Correspondence Address: SIDNEY WALLIS KILGORE, PENNINGTON, MOORE, WILKINSON, BELL & DUNBAR, PA, 2701 NORTH ROCKY POINT DRIVE- SUITE 900, TAMPA, FL, 33607-5975, US

(21) Appl. No.: 11/824,121

(22) Filed: Jun. 29, 2007

(51) Int. Cl. G06F 3/048

(52) U.S. Cl. 715/730

(57) ABSTRACT

A system, computer-implemented method and removable computer-readable medium with software for creating and displaying automatically and dynamically, in real time, from image and audio files stored on the removable computer-readable medium, a transient themed digital multimedia slide show presentation on a computer or other playback device. The only user preparation required is in the selection and transfer of the image and audio files to be used for the slide show presentation to the removable computer-readable medium. Upon insertion of the removable computer-readable medium into the removable media drive of a computer or other playback device, the software launches automatically and begins creating and displaying the slide show presentation with no further effort on the part of a user.

### CROSS-REFERENCES TO RELATED APPLICATIONS

Not applicable.

### STATEMENT REGARDING FEDERALLY SPONSORED RESEARCH OR DEVELOPMENT

Not applicable.

### MICROFICHE APPENDIX

Not applicable.

### BACKGROUND OF THE INVENTION

1. Field of the Invention

This invention relates to the field of generating and displaying digital multimedia presentations, particularly slide show presentations.

2. Description of Related Art

The proliferation of digital photography, by which photographic images are captured in digital format, has led to a need for elegant but easy, compact, and mailing-capable methods of sharing one's digital photographs with family members, friends, customers, and others. A popular format for sharing digital photographs is the slide show presentation, modeled on the traditional incremental, sequential display of photographic film slides by means of a light projector and an external screen.

In the traditional slide show, slides are physically inserted into a chamber or carousel in an operator-selected order. The projector operator controls the presentation by invoking commands to turn the projector lamp on and off, and to advance, reverse, or pause the sequence of slides. The projector shines a light source through the film of each slide, in turn, and through a system of lenses the image on the film can be focused, magnified, and projected onto an external screen for viewing by one or more persons.

In the context of digital photography, computer applications popularly known as slide presentation programs are typically used to create, edit, manage, store and display digital slide show presentations for display on a computer or other devices. A presentation consists of a collection of electronic “slides,” each of which corresponds to one screen or page of output. An electronic slide may contain one or more digital objects, such as photographs, graphical images, text, or audio files. Themed templates may be created for presentations in which all the slides in the presentation contain the same or similar graphics, text, or audio.

Using a slide presentation program, slides may be displayed on computer monitors, through projectors, and on television screens, among other devices. As with a traditional slide show, slides typically are displayed in an established sequence. The operator of the program, by way of a keyboard, mouse, or similar input device, can start and end the presentation, and advance, reverse, and pause the slides during presentation.

Optionally, a presentation may proceed automatically from slide to slide, without the need for an operator to advance the slides manually with an input device, based on pre-established display times for each slide selected by the author of the presentation or by the viewer. In this case, when the pre-established display time for the currently displayed time ends, the program advances to the next slide without operator intervention.

Digital slide show presentations may be stored on computer-readable media, including computer hard drives and other forms of fixed memory storage. Alternatively, they may be stored on removable storage media, such as Compact Discs (CDs), Digital Video Discs (DVDs.

CDs, DVDs, and other removable storage media can provide a means of distributing to others slide show presentations of digital photographs by hand or through the mail. Currently, however, computer programs used to create digital slide show presentations require substantial user interaction, user time, user experience, and a comfort level not shared by many novice or casual computer users. Moreover, users must install these programs on a computer hard drive before they may be used to create digital slide shows. While digital photographs can be simply stored on such removable storage media and distributed in that form, in the absence of any slide show presentation format, there is a consequent loss of consistency, aesthetics, and ease of use in the viewing experience.

Generally, the digital slide shows created by conventional side show presentation programs are fixed in a static executable file that may be stored and replayed using an appropriate application. Such files typically require the hard allocation of image and audio file resources and are dependent for their proper operation on the file names of those resources, precluding subsequent modification to the image and audio files that make up the presentation.

While slide presentations created by conventional slide presentation software may be stored on compact removable media and distributed to others by hand or by mail, or transmitted electronically—typically over the internet as an attachment to an e-mail—the recipients ordinarily must have access to the same slide presentation software or some other compatible form of software on their own computers or player devices in order to display the presentations. Using imperfectly compatible software applications to replay such static slide show presentations can result in a unacceptable loss of uniformity from viewing to viewing among an intended audience. This obstacle tends to inhibit the ability to share digital slide show presentations with others, particularly less technologically sophisticated recipients who may require a means of viewing such presentations with minimal knowledge and effort.

### BRIEF SUMMARY OF THE INVENTION

The present invention comprises a system, computer-implemented method and removable computer-readable medium with software for creating and displaying, dynamically and automatically in real time, solely from image and audio files stored on the removable computer-readable medium, a transient themed digital multimedia slide show presentation on a computer or other computing device for playback.

### BRIEF DESCRIPTION OF THE SEVERAL VIEWS OF THE DRAWINGS

FIG. 1 is a diagram of a computer system that can be used to prepare the removable computer-readable medium for creating and displaying a transient themed digital multimedia slide show presentation, and for displaying the same, using a CD-based enablement of the removable computer-readable medium.

FIG. 2 is a flow chart illustrating the typical process by which a user would prepare the removable computer-readable medium for generating and displaying dynamically and in real time a transient themed digital multimedia slide show presentation.

FIG. 3 through FIG. 18 present a series of Windows® XP screen shots reflecting, in a CD-based enablement, one possible version of interactive help providing a user with information and instructions regarding the preparation of the CD to create and display a transient themed digital multimedia slide show presentation when no image file has been detected on the CD and the user may require such information and instruction in order to use the CD:

FIG. 3 shows the screen as the executable completes loading before displaying the first interactive information and help screen.

FIG. 4 illustrates the first interactive help screen providing an overview of the CD-preparation process.

FIG. 5 reflects a screen that explains that users must burn image and audio files to the CD using an application of their choosing.

FIG. 6 shows how a user might be instructed as to a protocol for renaming the image files to ensure which images will be displayed in what order.

FIG. 7 demonstrates how a user might be instructed as to renaming image files to cause desired captions to be displayed with the images.

FIG. 8 illustrates how a user might be shown a example of how a caption will appear to a viewer when displayed with an image.

FIG. 9 shows how a user might be instructed in acceptable audio file formats and in renaming an audio file to ensure that it loops continuously while a slide show is running.

FIG. 10 reflects a typical introductory page for frequently asked questions (FAQs).

FIG. 11 shows a World Wide Web (WWW) site that a browser might be made to display when a control on the introductory FAQ page is activated.

FIG. 12 THROUGH FIG. 18 each reflects various typical questions of users and the answers that may be presented.

FIG. 19 is a flow chart illustrating the background process by which the invention creates and displays dynamically and automatically in real time a transient themed digital multimedia slide show presentation in which the removable computer-readable medium is a hockey-rink shaped CD running in a graphical user interface (GUI) operating environment using the Microsoft® Windows® XP operating system from one or more image files and one or more audio files already stored on the CD.

FIG. 20 through FIG. 28 present a series of screenshots reflecting an example of what a user typically might see while using the removable computer-readable medium to view a transient themed digital multimedia slide show presentation using a computer system for playback:

FIG. 20 shows a user screen as the executable completes loading and prepares to begin displaying the multimedia digital slide show presentation.

FIG. 21 shows a splash screen that might be displayed to a user to allow the user to become familiar with certain keyboard controls in advance of displaying the slide show presentation.

FIG. 22 shows the initial display of a pre-determined background image template, before any images are displayed.

FIG. 23 shows a first image from the image files in an ordered sequence of presentation as displayed in the foreground of a background image template within a designed X-Y plane located within the display area of the template, as well as some graphically presented controls for the display of the presentation.

FIG. 24 illustrates a pause indicator displayed following activation of a pause button control pausing the presentation on the first image.

FIG. 25 reflects a second image displayed within the same template following release of the pause button control.

FIG. 26 shows a full-frame version of the second image displayed after a toggle control has been activated.

FIG. 27 reflects what the user might see following activation of an information display control.

FIG. 28 illustrates a splash screen a user might see following activation of an exit control.

### REFERENCE NUMERALS IN THE DRAWINGS

110 Computer with processor, memory, and operating environment
120 Hard drive (non-volatile memory storage device)
130 Keyboard
140 Two-Button Mouse
150 Computer monitor (transient display device)
160 External speakers (audio output device)
170 CD-ROM drive (removable media drive)
180 CD-ROM (removable computer-readable media with software)

### DETAILED DESCRIPTION OF THE INVENTION

The present invention allows a user to prepare and distribute simple but elegant transient themed digital multimedia slide show presentations with minimal effort and without having to install any slide show presentation software on a computer system. Each slide show presentation is transient in that the invention creates and displays, within the same dynamic process in real time, a fresh slide show presentation from image and audio files stored on a removable computer-readable medium each time that removable computer-readable medium is inserted into a removable media drive incorporated in or attached to a computer or other suitable playback device. The software launches automatically and begins creating and displaying the slide show presentation with no further effort on the part of a user. The only user preparation required is in the selection and transfer to the removable computer-readable medium the image and audio files to be used for the slide show presentation.

The removable computer-readable medium for the invention can include any kind of computer memory not fixed inside a computer, such as optical discs (e.g., circular CDs and shaped CDs, such as ‘hockey-rink’ CDs, and Digital Video Discs), floppy disks, Zip disks, memory cards, and Flash ROM devices. The executable software on the removable computer-readable medium that creates and displays the slide show presentation can be implemented using any number of languages, such as C++, Java, or Lua. One enablement can be produced with an off-the-shelf WYSIWYG (what-you-see-is-what-you-get) editor, such as Auto Play Media Studio v. 6.0™.

Any number of computer systems—combinations of hardware and software—could be used to prepare the removable computer-readable medium. One such system would include a computer with a microprocessor, memory, an operating environment and operating system; a transient display device for displaying computer-generated output (such as a Cathode ray tube, liquid crystal display, or a plasma display, either in the form of a computer monitor or as implemented by a video projector); and audio output device, such as external speakers; one or more input devices, such as a keyboard or a mouse with one or more buttons or other controls; one or more non-volatile memory storage devices, such as a hard drive, floppy drive, or optical disc drive storing one or more image files and zero or more audio files; a removable media disk to read and write to the removable computer-readable medium with the software for creating and displaying the slide show presentations; and any software required to record, encode or store the image files from hard drive or other non-volatile memory storage device to the removable media device for the removable computer-readable medium with the executable software for creating and displaying a transient themed digital multimedia slide show presentation.

The operating environment for the computer would ideally be a graphical user interface (GUI). Suitable operating systems could include various Microsoft® Windows® products (Vista, XP, 2000, NT, ME, 98) or Linux or other Unix-style products (such as OSX). Where the enablement for the removable computer-readable medium is an optical disc, authoring software, also known as encoding or “burning” software, will be required to effectuate storage by encoding the files on the optical disc. The term ‘burning’ refers to the encoding of files to an optical disc or other optical storage medium. In the case of a CD, such software is commonly referred to as CD authoring, CD encoding, or CD burning software.

Image files to be used to create a slide show presentation may typically be in JPEG (Joint Photographic Experts Group) format, but other formats, e.g., BMP (Bit Mapped), GIF (Graphic Interchange Format), PNG (Portable Network Graphics), or TIFF (Tagged Image File Format), could be enabled. Suitable audio files formats could include, without limitation, AIFF (Audio Interchange File Format), MP3 (MPEG-1 Audio Layer 3), Ogg (an open standard for a free container format for digital media), WAV (WAVEform), and WMA (Windows Media Audio).

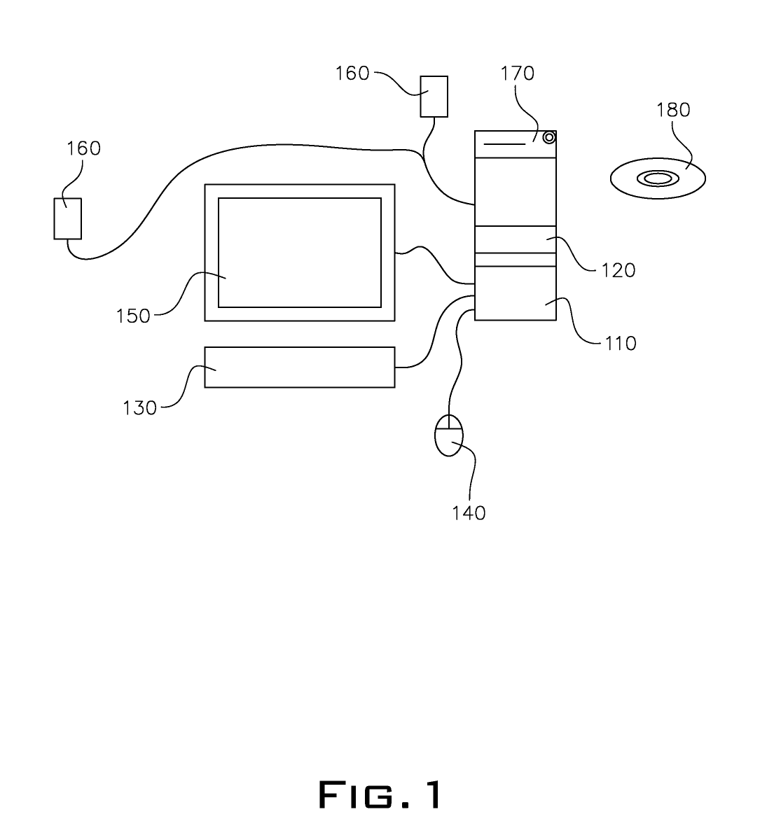

FIG. 1 illustrates one possible computer system on which a user could prepare a CD-based enablement of the removable computer-readable medium to create and display a transient themed digital multimedia slide show presentation using an operating environment that could include a graphical user interface (GUI), provided within an operating system such as Microsoft® Windows® XP, and CD authoring software, such as Easy Media Creator 9® by Roxio®. This system includes a computer with processor, memory, and operating environment 110, a hard drive 120 providing non-volatile memory storage device, a keyboard 130, a two-button mouse 140, a computer monitor 150 that serves as a transient display device, external speakers 160 providing an audio output device, a CD drive 2770 for a removable media drive, and a CD 180 serving as a removable computer-readable medium. The CD contains an executable software file that creates and displays, dynamically and automatically in real time, from the image and audio files that a user has selected and stored on the CD, a transient themed digital multimedia slide show presentation on a computer or other computing device suitable for playback.

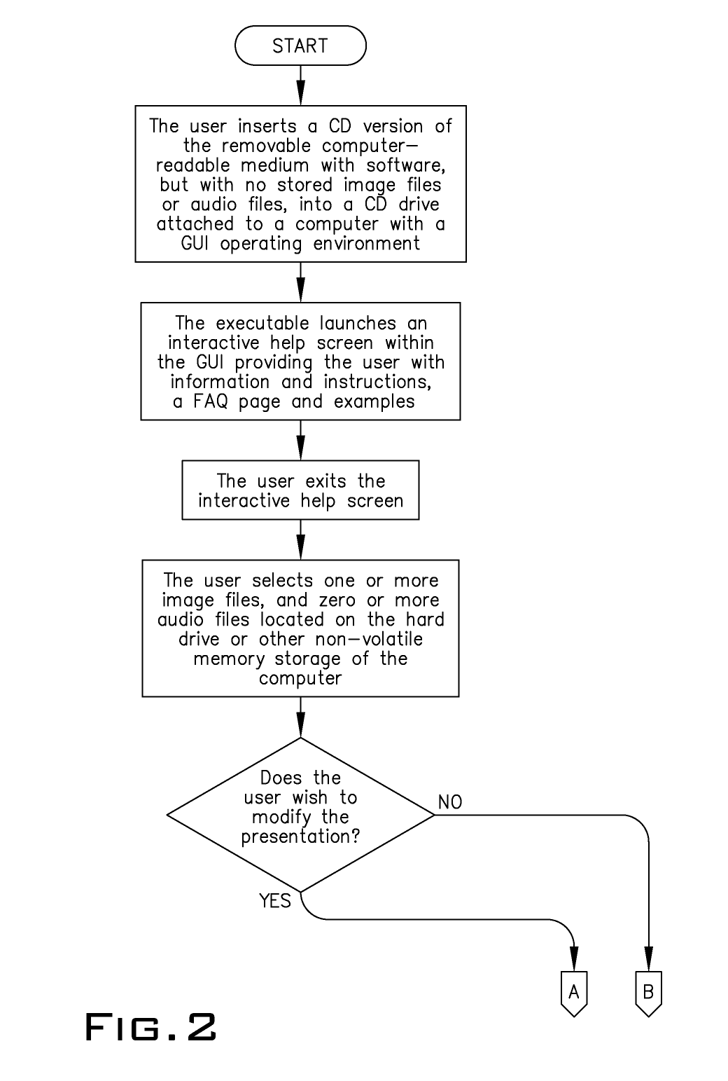

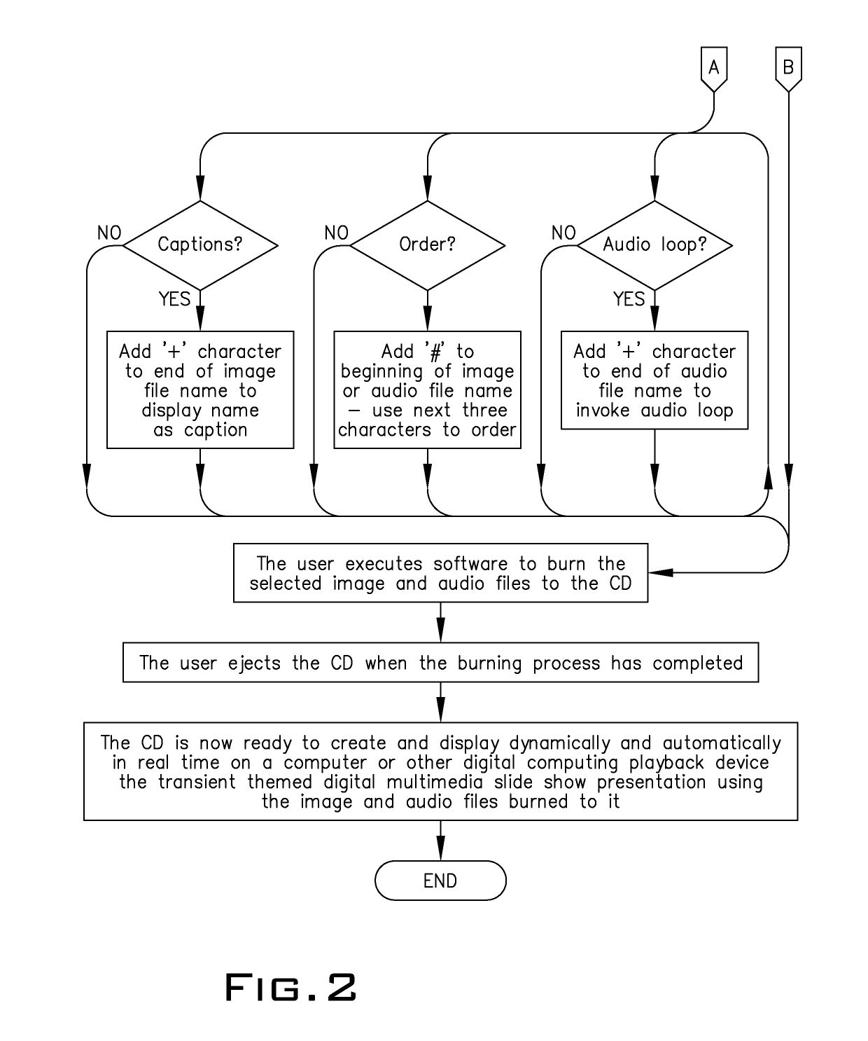

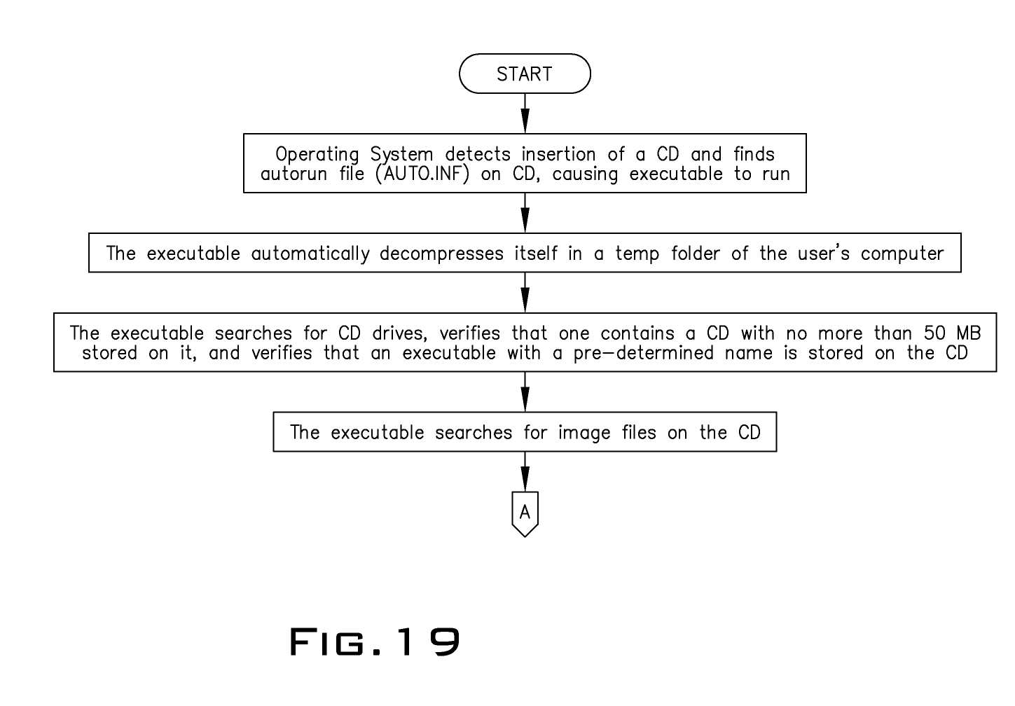

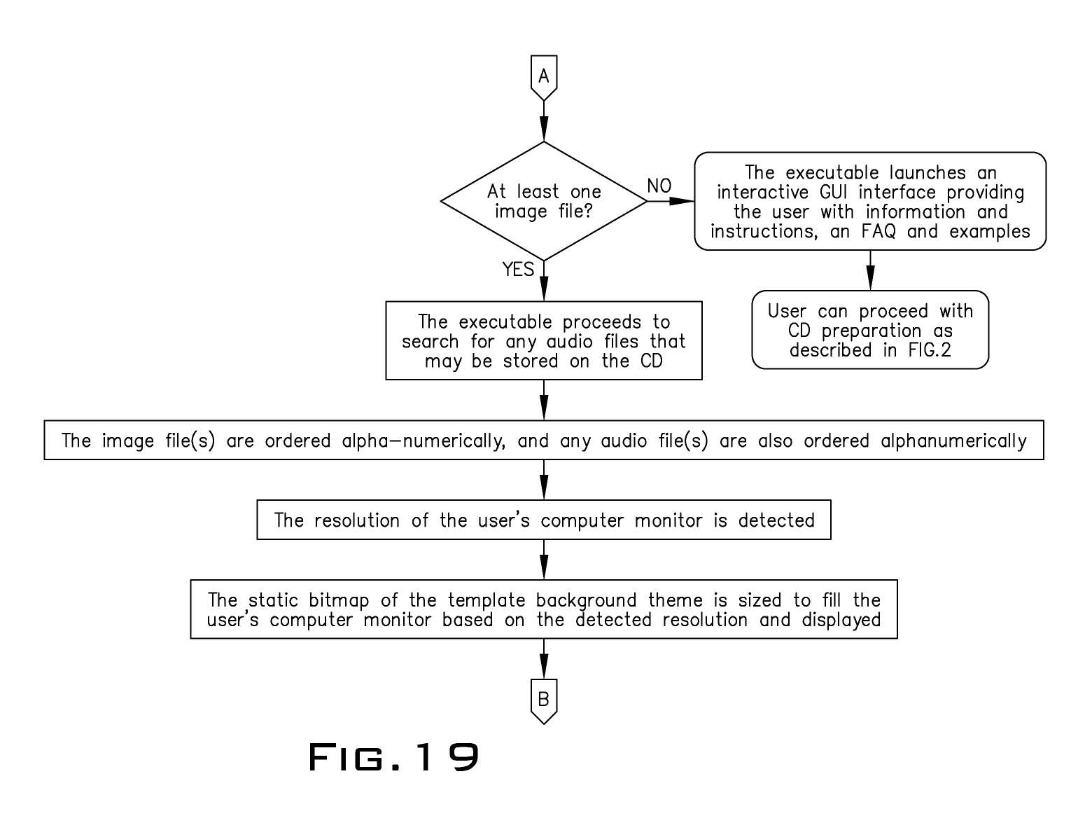

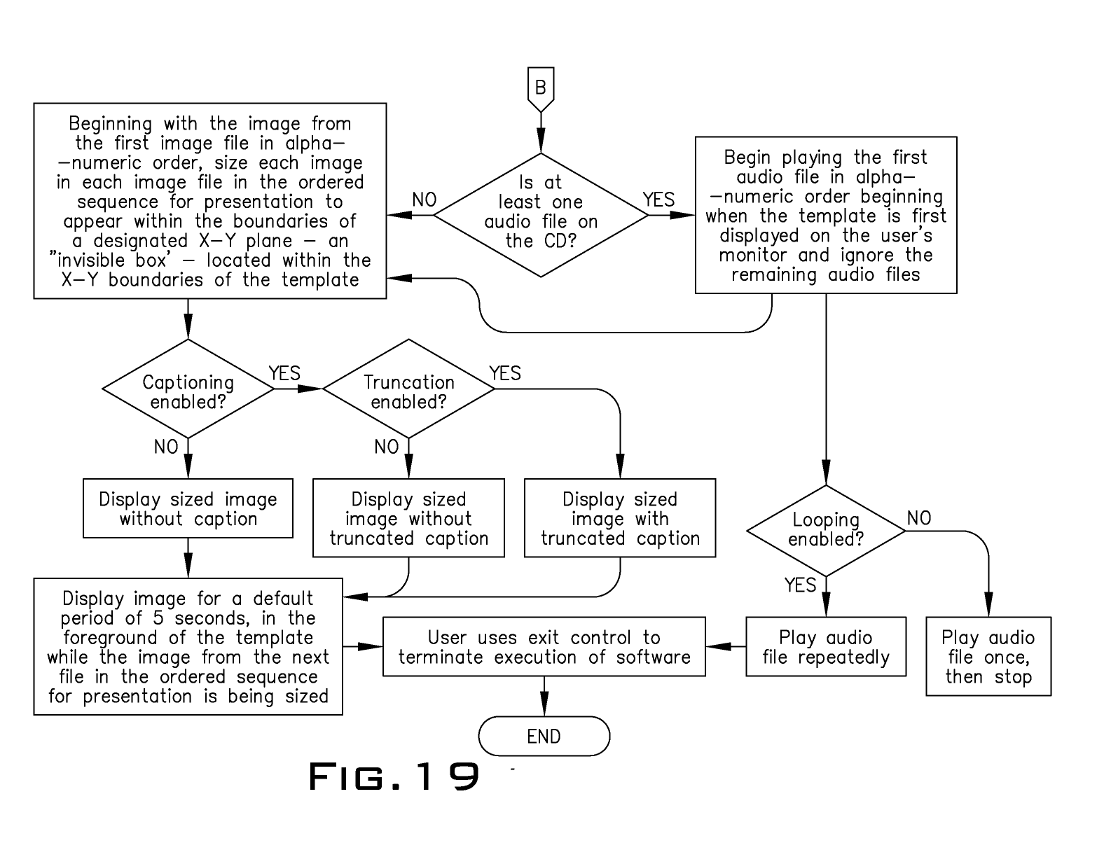

FIG. 2 is a flow chart illustrating one process by which a user could prepare a CD-based enablement of the removable computer-readable medium for generating and displaying dynamically and in real time a transient themed digital multimedia slide show presentation. To prepare the CD, the user would first insert it into the CD drive. Assuming there is no image file on the CD, the executable file launches an interactive help screen within a GUI providing the user with information and instructions, a Frequently Ask Questions (FAQ) page, and examples of use. The background process by which the software determines whether to launch the interactive help screen is described more fully below with reference to FIG. 19.

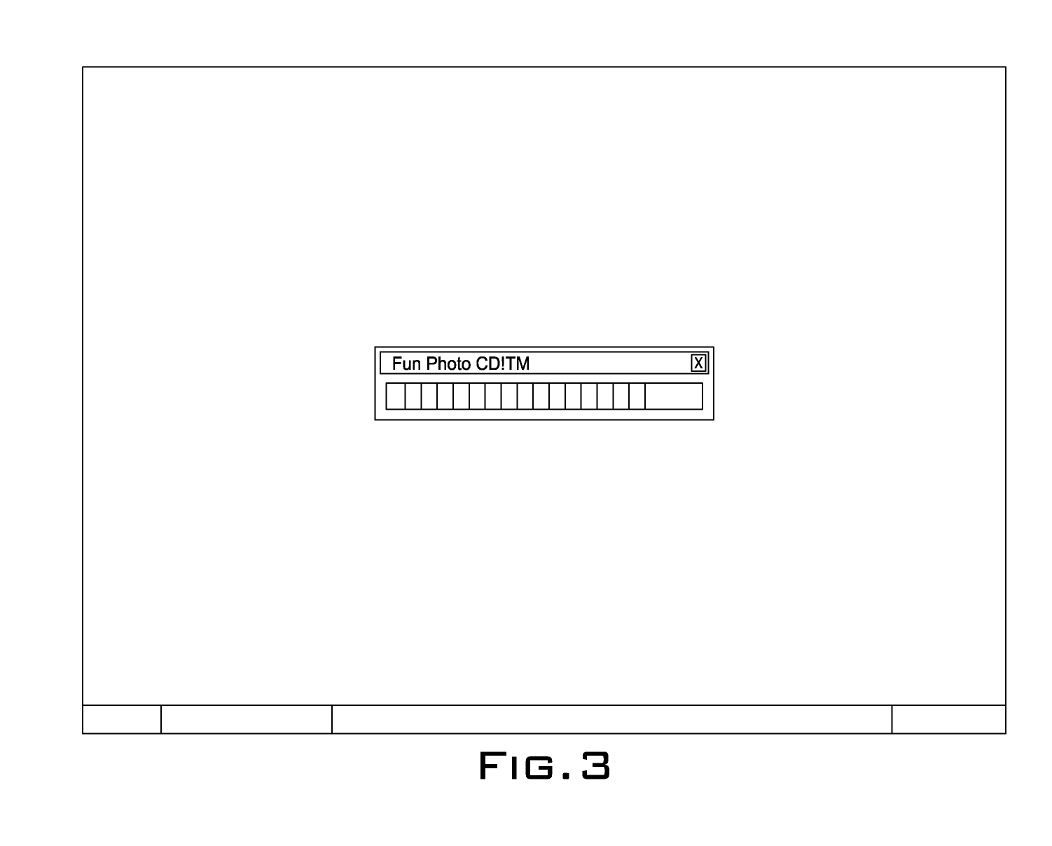

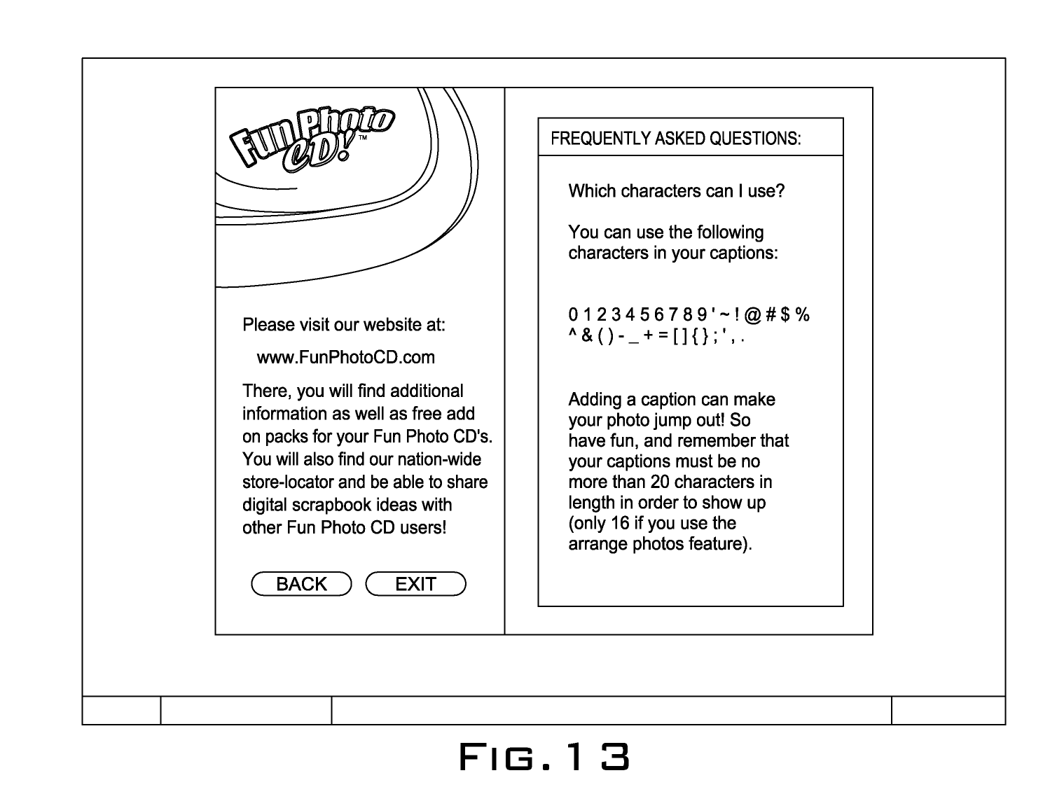

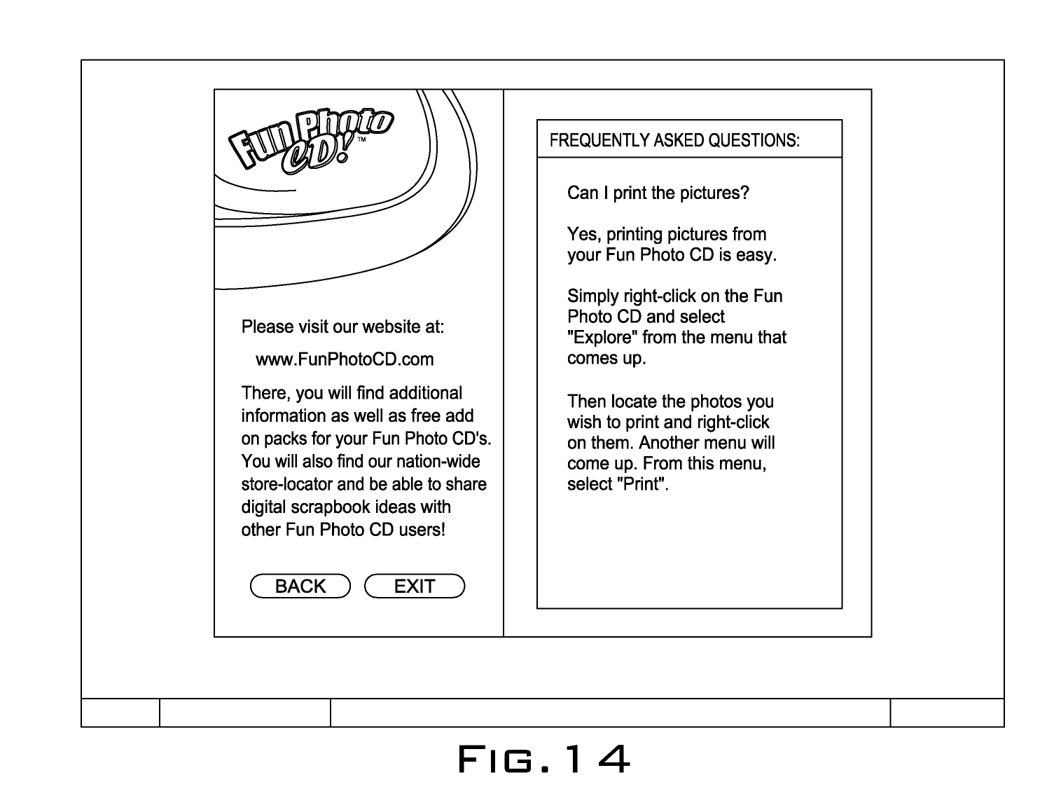

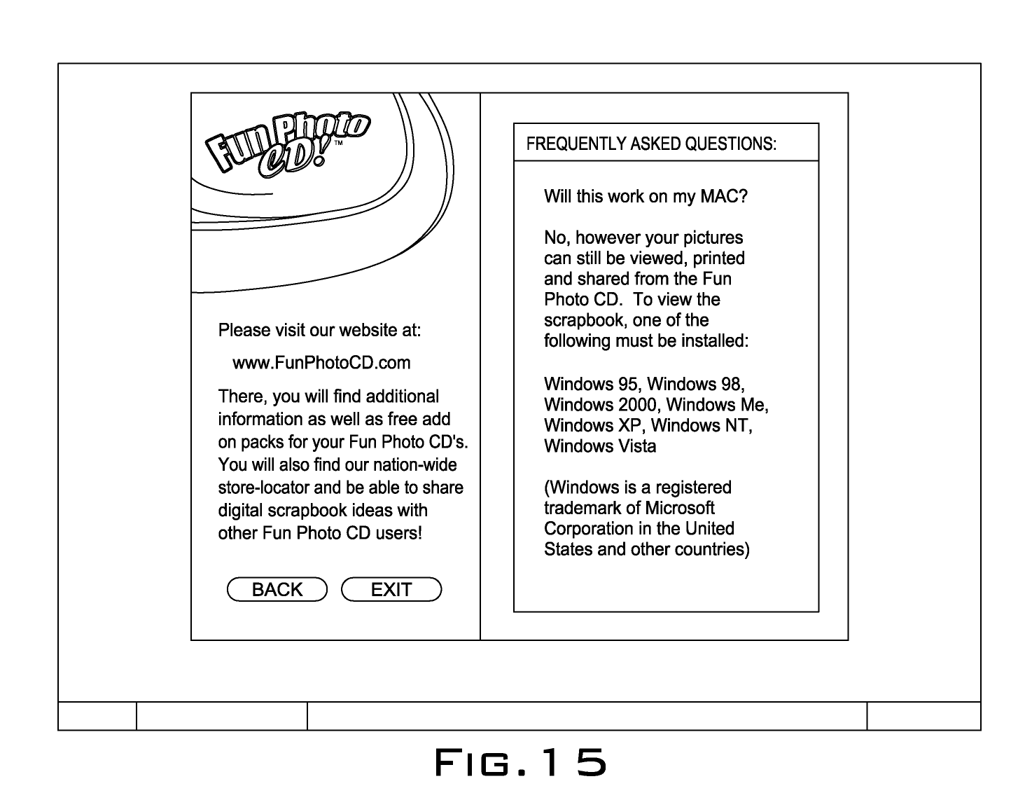

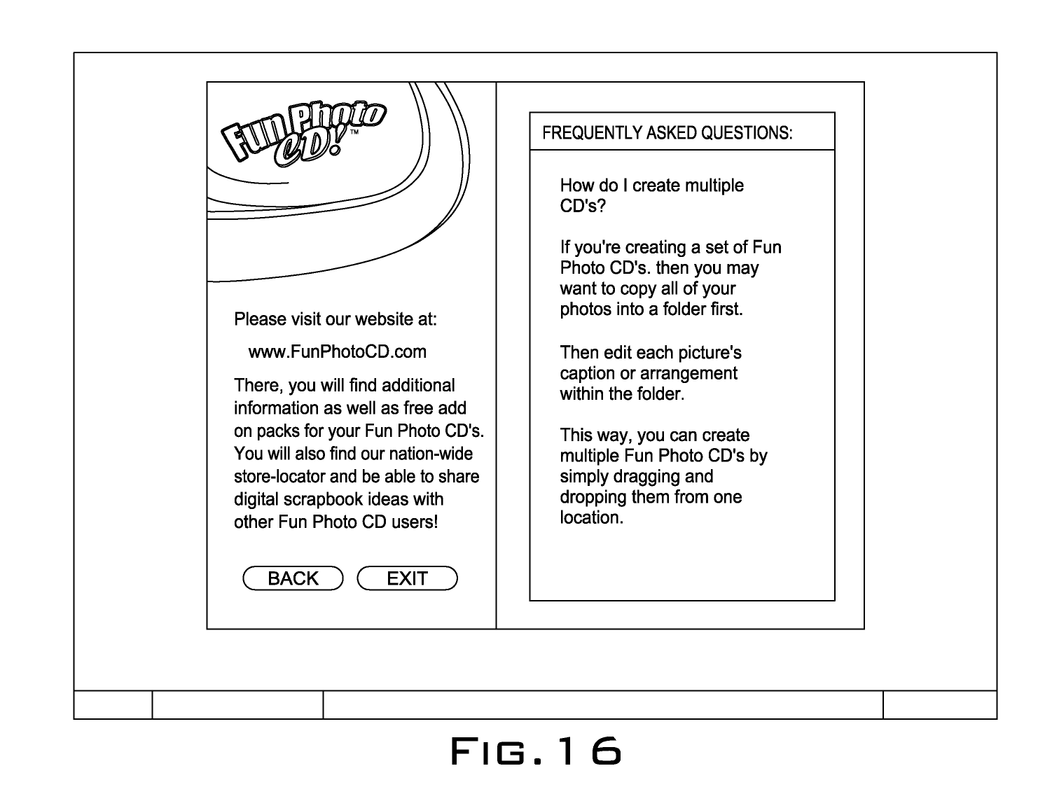

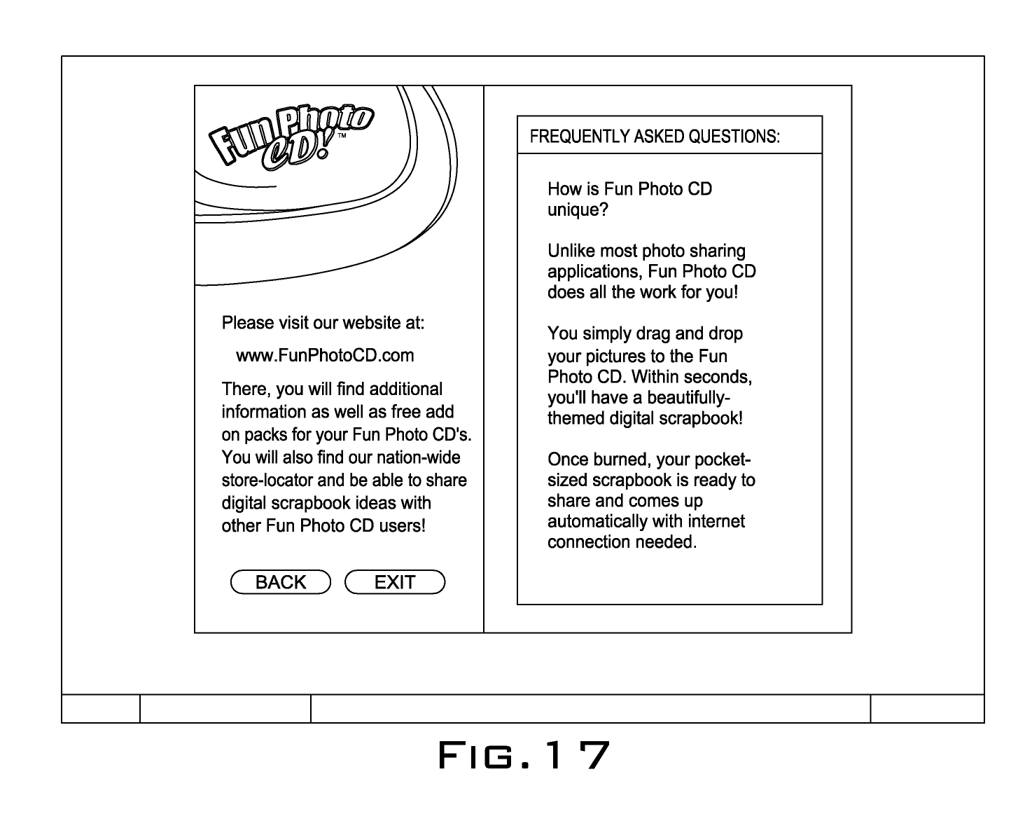

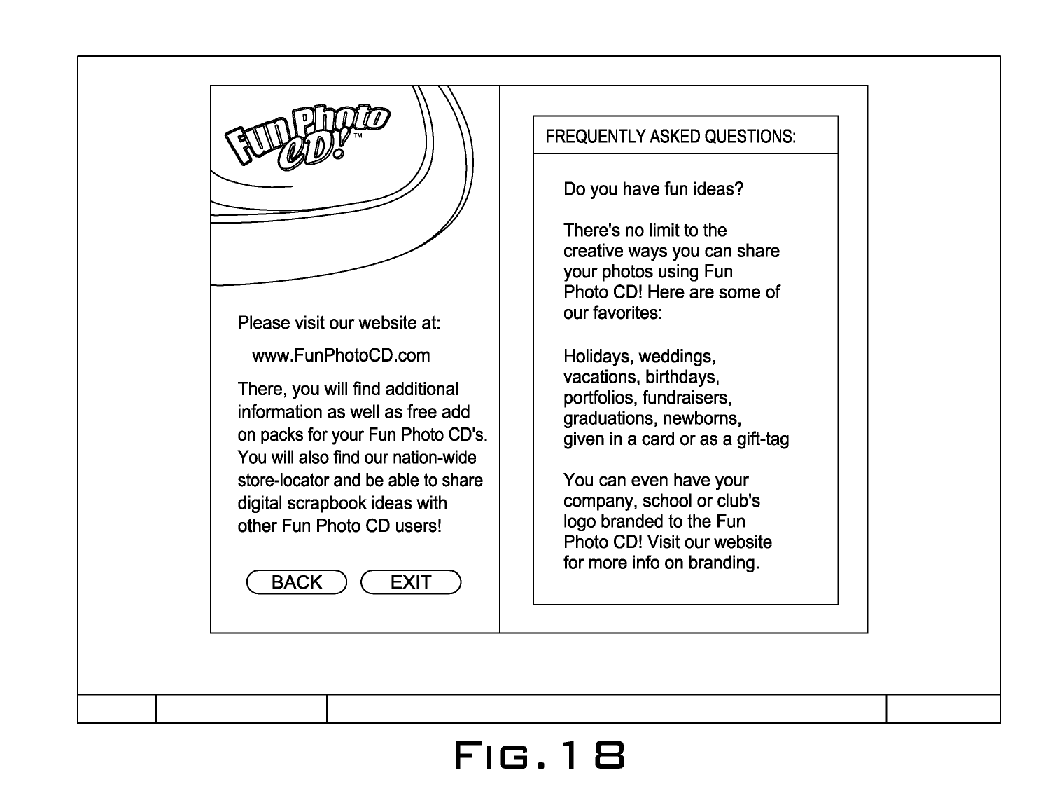

FIG. 3 through FIG. 18 present a series of Windows® XP screen shots reflecting, in a CD-based enablement, one possible version of interactive help providing a user with information and instructions regarding the preparation of the CD to create and display a transient themed digital multimedia slide show presentation when no image file has been detected on the CD and the user may require such information and instruction in order to use the CD. The user may navigate through the interactive help screen using a mouse. If a user is already familiar with how to use the invention, the user can exit the interactive help screen immediately by clicking on the exit button with a mouse or depressing the Esc key or other designated key on a keyboard.

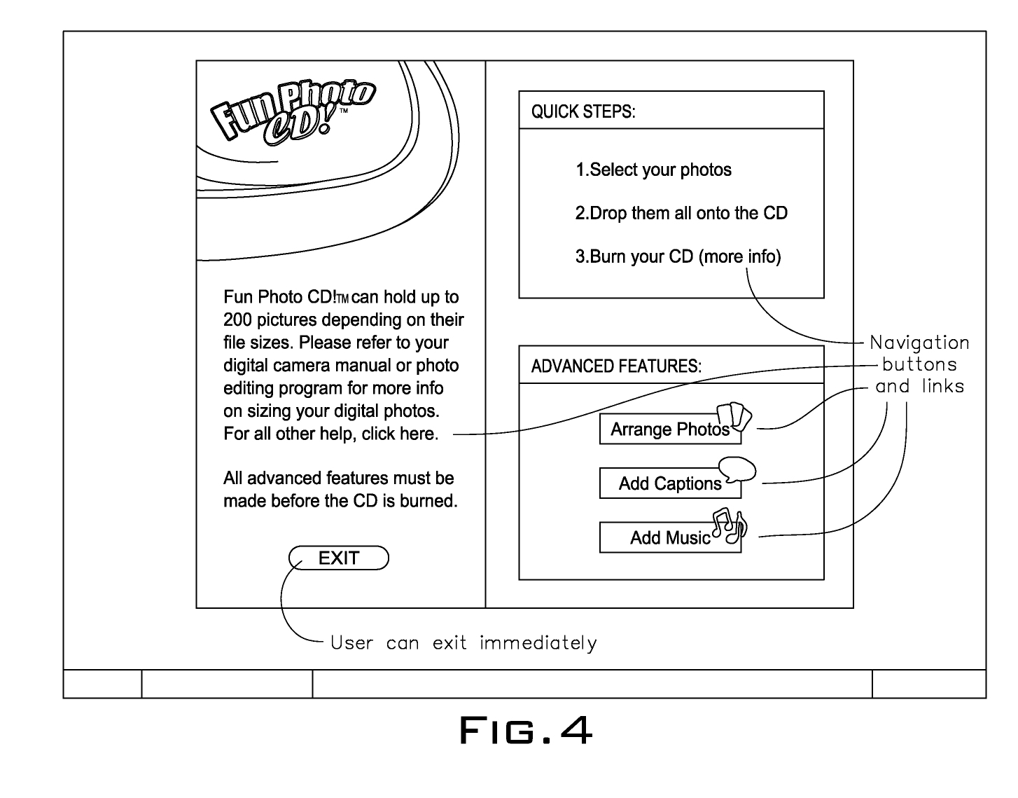

FIG. 3 shows the screen as the executable completes loading before displaying the first interactive information and help screen. FIG. 4 illustrates the first interactive help screen providing an overview of the CD-preparation process.

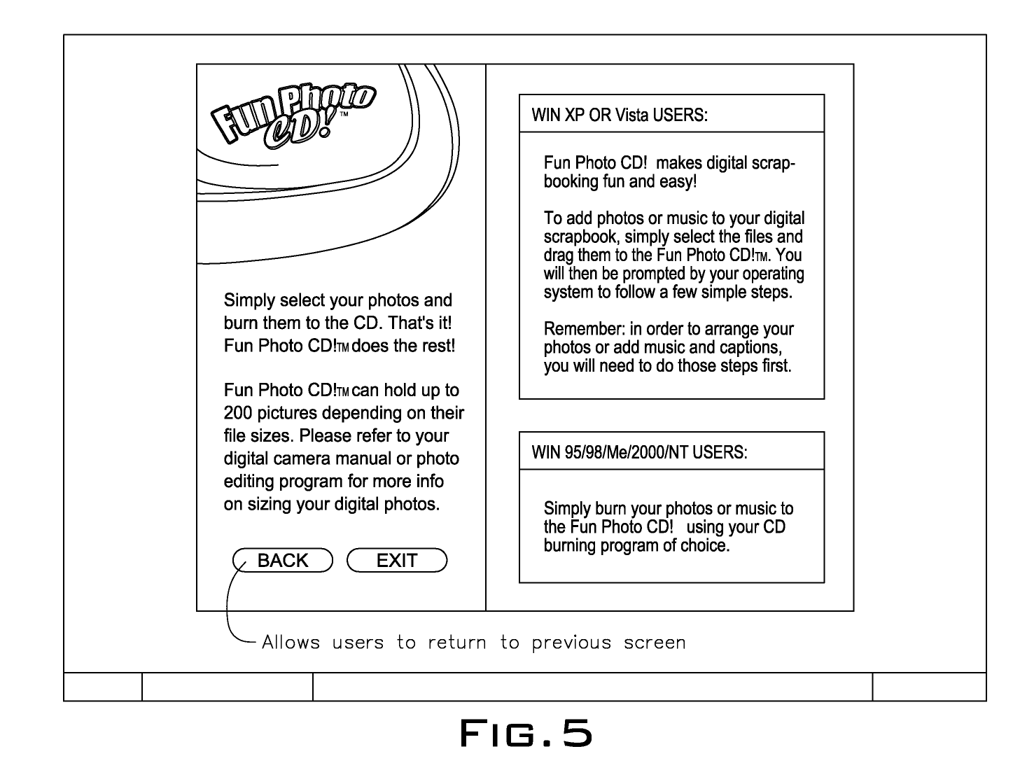

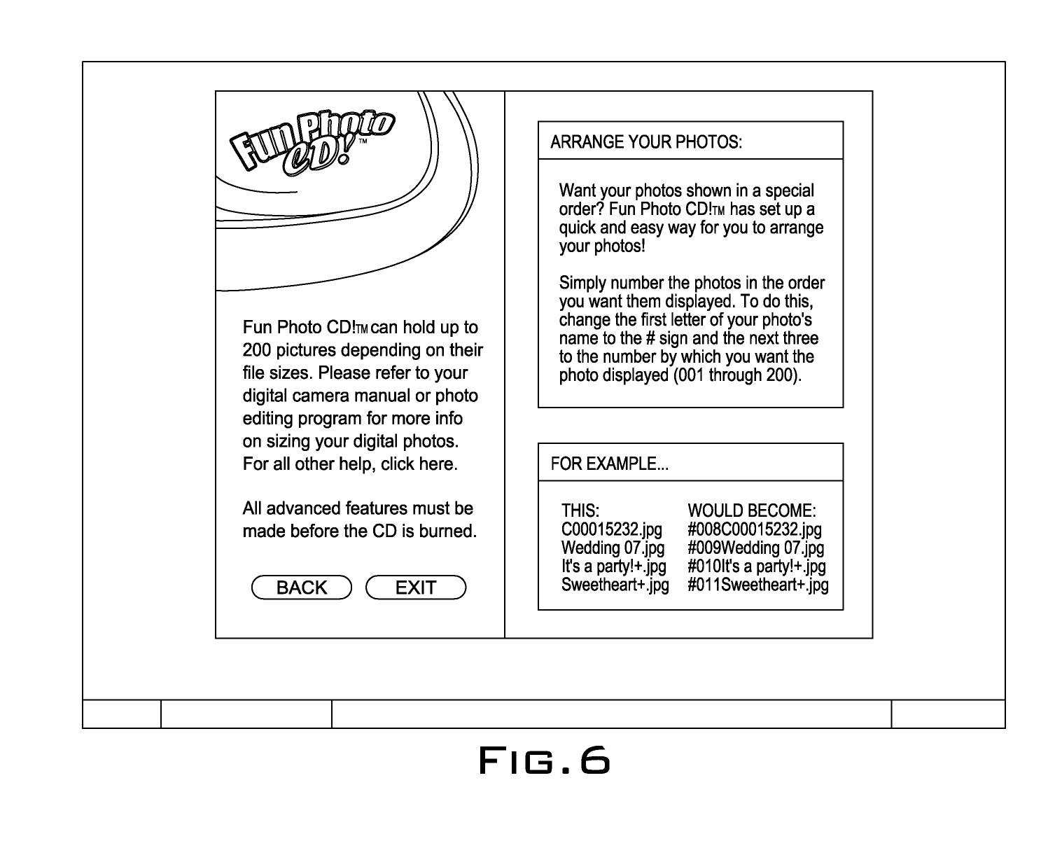

FIG. 5 reflects a screen that explains that users must burn image and audio files to the CD using an application of their choosing. FIG. 6 shows how a user might be instructed as to a protocol for renaming the image and audio files to ensure which images and audio will be displayed and played, respectively, and in what order.

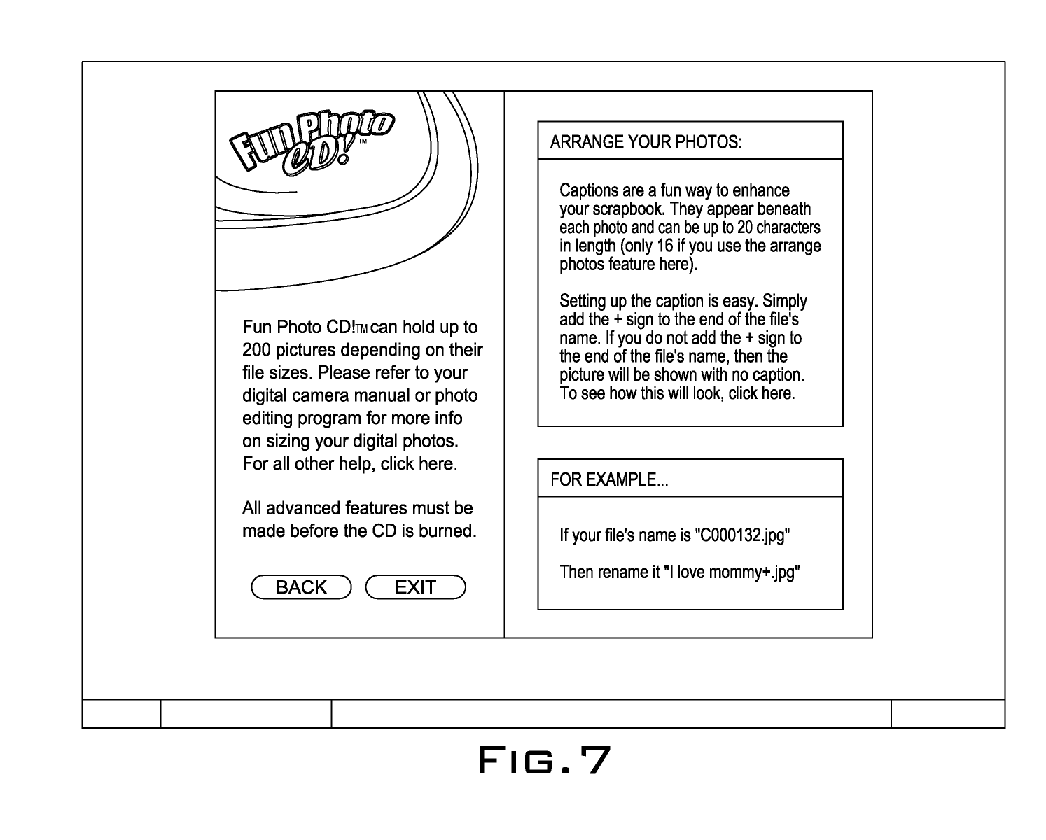

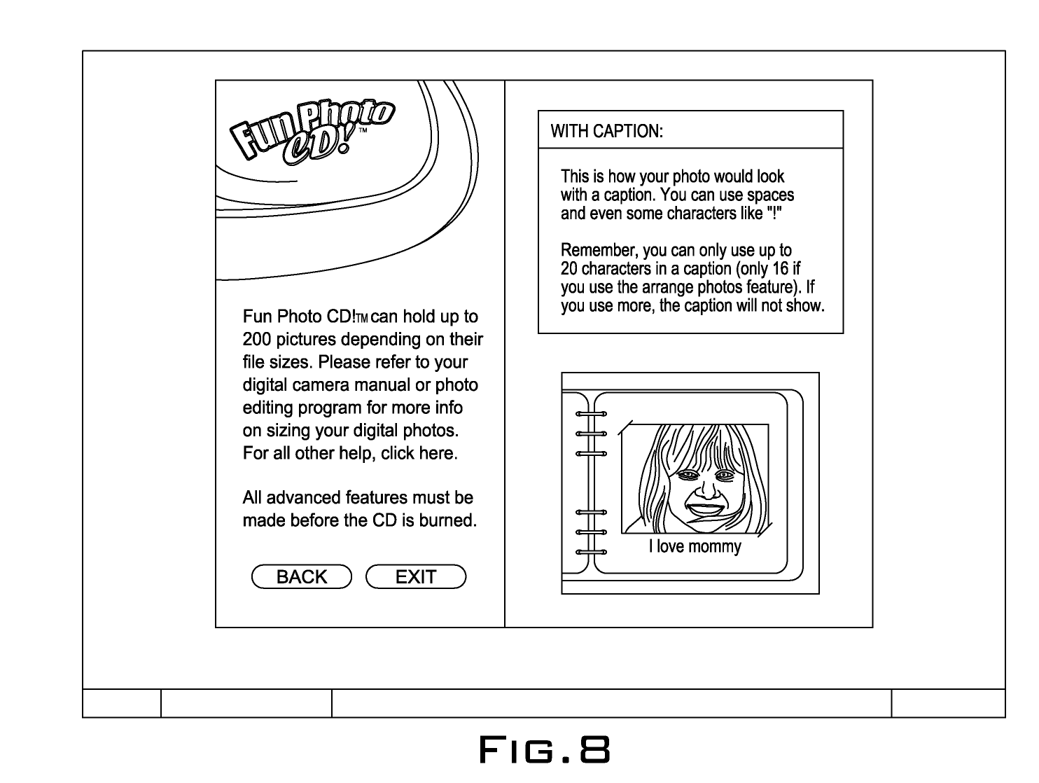

FIG. 7 demonstrates how a user might be instructed as to renaming image files to cause desired captions to be displayed with the images. FIG. 8 illustrates how a user might be shown an example of how a caption will appear to a viewer when displayed with an image.

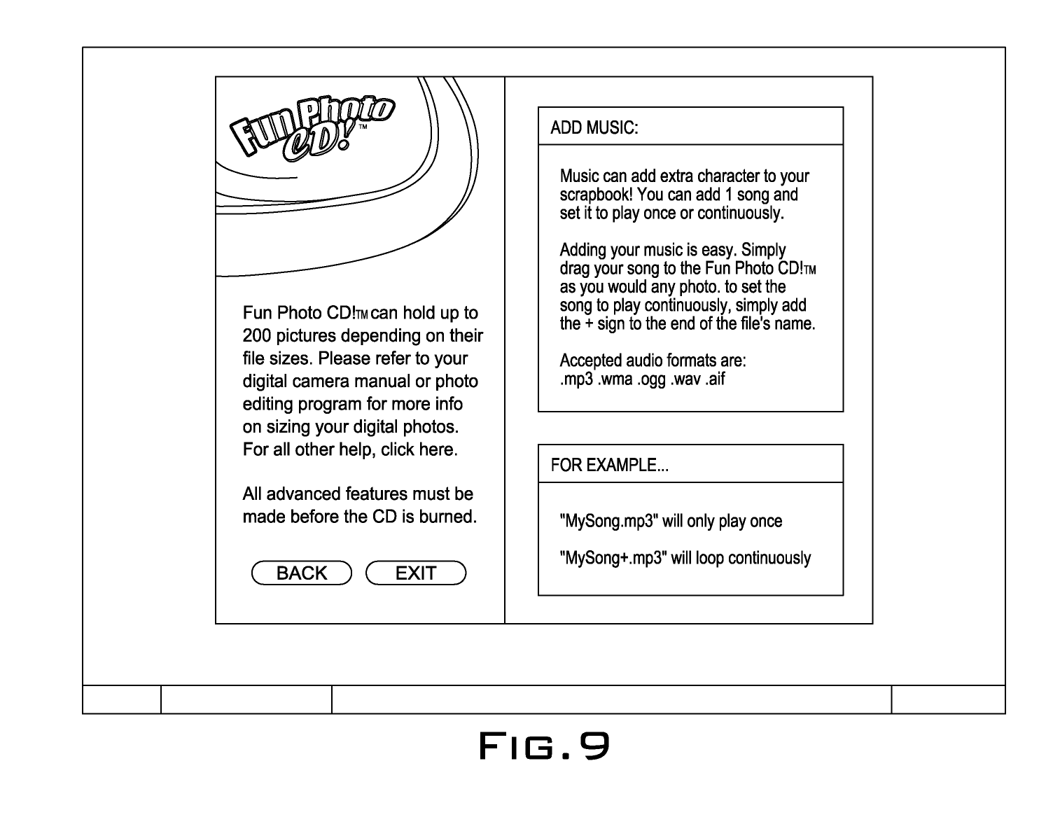

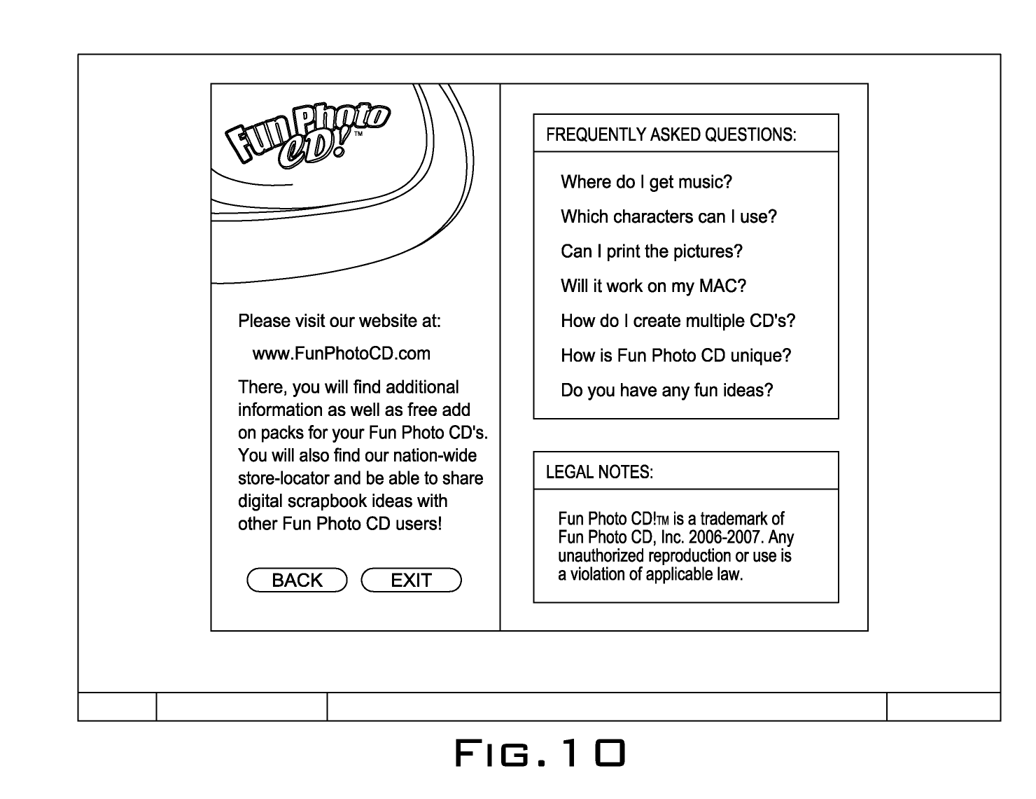

FIG. 9 shows how a user might be instructed in acceptable audio file formats and in renaming an audio file to ensure that it loops continuously while a slide show is running. FIG. 10 reflects a typical introductory page for frequently asked questions (FAQs).

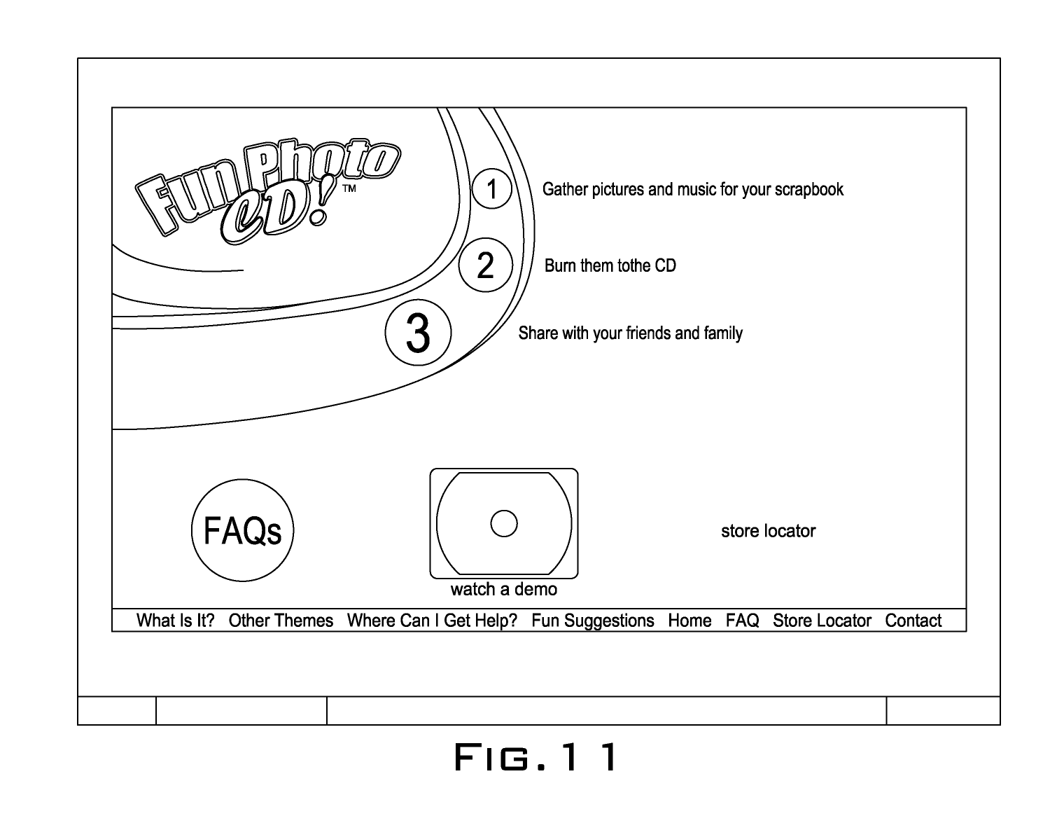

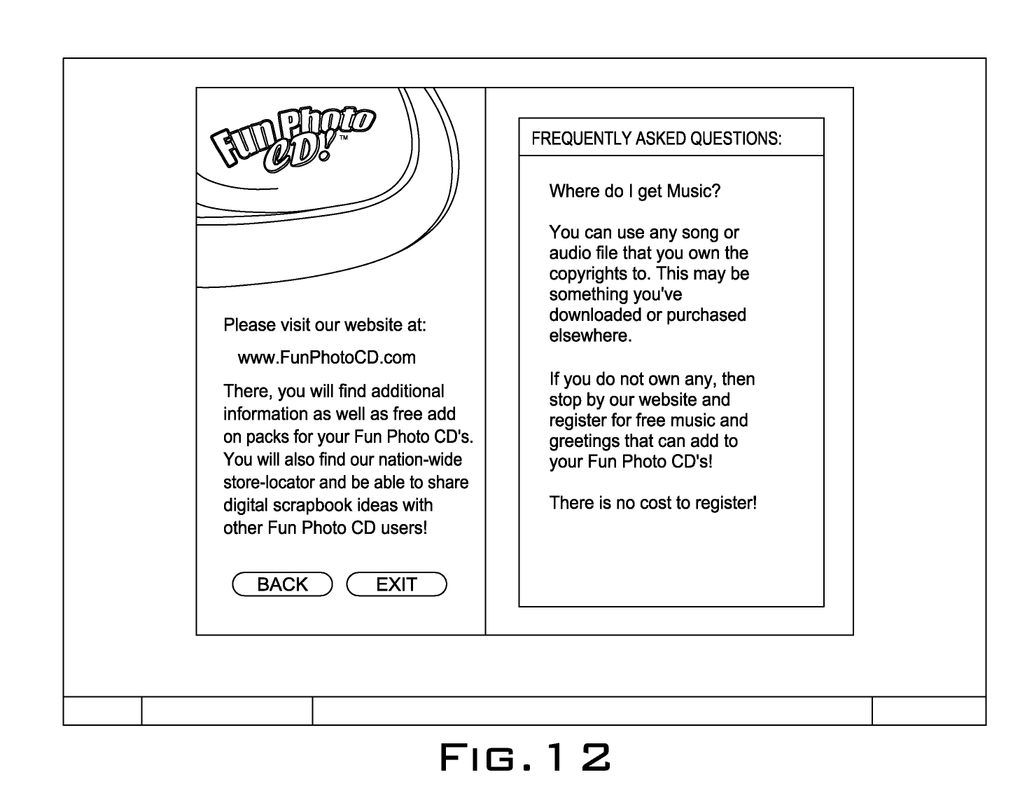

FIG. 11 shows a World Wide Web (WWW) site that a browser might be made to display when a link control on the introductory FAQ page is activated. The screen shots in FIG. 12 THROUGH FIG. 18 each reflect various typical questions of users and the answers that may be presented.

The user exists the interactive help screen by using either a mouse or keyboard control. The user can then select one or more image files, and optionally one or more audio files, stored on the hard drive. Using the mouse, the user would drag and drop those files onto the CD and encode (‘burn’) them to the CD with the CD authoring software. The preparation process is complete, and the CD may be removed from the drive. The CD, and indeed, other forms of optical storage media, such as a DVD, can be prepared using an ‘open burn’ to allow the encoding of additional image and audio files at a later date.

Optionally, in the enablement shown in FIG. 2, the user can elect to modify the presentation to display images with captions, to display them in a particular order, and to cause any audio file to play in a loop throughout the presentation by modifying the file names of the image and audio files selected before burning them to the CD. To cause a caption to appear under an image when it is displayed during a presentation, the user appends a pre-determined non-alpha-numeric character to the end of the file name before any extension, in this case, a ‘+’ sign. Thus, if the file name is ‘002812007.jpg’, the user would change the file name to read ‘002812007+.jpg’ and the file name ‘0028112007’ would be displayed as a caption under the image when the image is displayed. The user can also change the file name itself prior to burning the file to the CD.

The user can opt to control the order of display by prefixing to the beginning of the file name of either an image or audio file a pre-determined non-alpha-numeric character, in this case, a ‘#’ sign. By default, the image files are ordered sequentially for display in the alpha-numeric order of their file names. Audio files are handled the same way. The # prefix immediately preceding a file name signals the computer that it should not display the # and the first three characters of the file name, truncating the file name. This allows the user to harness the alpha-numeric default to re-order the file order, while retaining meaningful names for the images during the presentation. For the three characters after the # sign, the user orders the files in a systematic alpha-numeric sequence of his choosing, e.g., ‘#001[filename]’, ‘#002[filename]’, ‘#003[filename]’, etc., renaming the files accordingly before burning the files to a CD. The computer will present the files in the alpha-numeric order designated by the first three characters following the # sign, but will display only the filenames. The same technique can be used to modify the order of audio play in the event that more than one audio file is present on the CD.

In this particular enablement of the invention, only the first audio file in alpha-numeric order is played during the presentation, regardless of the presence of additional audio files. An audio file can be made to play continuously in a loop throughout the presentation of images at the option of the user where the user has appended a pre-determined character to the end of the audio file before the extension, in this particular enablement, a ‘+’ sign, before the file is burned to the CD. The computer can distinguish between the ‘+’ sign as applied to an image file versus its application to an audio file.

FIG. 19 is a flow chart illustrating the background process by which the invention creates and displays dynamically and automatically in real time a transient themed digital multimedia slide show presentation in which the removable computer-readable medium is a hockey-rink shaped CD running in a graphical user interface (GUI) operating environment using a Microsoft® Windows® XP operating system. This particular enablement utilizes an AUTORUN.INF file placed in the root directory of the CD to launch the software executable file automatically upon insertion of the CD into the CD drive.

The process begins when the user inserts a CD into a CD drive. The operating system detects the insertion of the CD and finds the autorun file (AUTO.INF), which causes the executable software file (‘executable’ or ‘executable file’) on the CD to run.

The executable decompresses itself automatically in the temporary folder of the user's computer, after which it searches for CD drives on the computer system and proceeds to identify which of these drives contains the CD on which the slide show presentation software resides. It does so informally by checking to ensure that the total storage on the CD does not exceed 50 megabytes, and that the file name of the executable software file containing the slide presentation software resides on the CD.

After this initial verification process, the executable proceeds to search for all image files stored on the CD. If it finds no image files on the CD with which to create and display a slide show presentation, the executable launches an interactive GUI interface as described above to provide the user—who may never before have used the invention, or may have forgotten how to use it—with information and instructions, a Frequently Asked Questions (FAQ) page, and various examples of how the invention may be used and what the normal results will be. After closing the interactive interface, the user may proceed to drag and drop image and audio files onto the CD and burn it to prepare a slide show presentation.

If the executable file finds at least one image file on the CD, it immediately will begin the process of creating and displaying a slide show presentation. First, after gathering all the image files, it will search for all audio files on the CD. The image and audio files are separately put in alpha-numeric order based on their names, which will become the ordered sequence of presentation of the images in the image files and the ordered sequence of playing of the audio files.

Next, the executable detects the resolution of the user's computer monitor or other transient display device. A static bitmap of a pre-determined background image template serves as a backdrop theme for the slide show presentation. The possible themes are virtually unlimited. One popular theme is a background picture of a photo album, which can be particularized for different holidays and other occasions.

The bitmap is sized—in common parlance, ‘stretched’—to fill the maximum display area on the user's computer monitor or other transient display device based on the display resolution detected by the executable. The background template image is then displayed throughout the slide show presentation as a static backdrop to the images displayed from the image files in the ordered sequence of presentation until the program exits, except during periods when the user has elected to display images in full-screen size without the background template image.

At this point, when the background image template is first displayed, if there is at least one audio file on the CD, the executable will cause that audio file to play. If more than one audio file is present, the executable will play only the first audio file in the ordered sequence of playing, i.e., the first file in alpha-numeric sequence. The file will play only one time and stop, unless the user has enabled a looping option, in which case the audio file will continue to play over and over until the execution of the software is terminated.

Beginning with the first image file, and continuing thereafter with each successive image file in the alpha-numerically ordered sequence of presentation, the software sizes each image, based on the detected dimensions of each image, to appear within the boundaries of a pre-determined X-Y plane—which is an “invisible box” not appearing on the display—located within the plane of the background image template displayed. The X-Y plane, therefore, essentially determines the location where the image is to be displayed against the background image template, but is not a visible element of the slide show presentation. The dimensions of the X-Y plane, and its location relative to the background image template, will vary with the detected resolution of the transient display device, requiring dynamic sizing of the images so that they may be displayed consistently in relation to the background template regardless of the particular display resolution of the computer monitor or other transient display device being used to view the slide show presentation.

Once the sizing calculation for an image file is complete, it is displayed within the boundaries of the X-Y plane in the foreground of the background image template. The file name is displayed as a text caption below the displayed image, if a user has configured the file name appropriately during the preparation of the CD. If the user has inserted a ‘#’ sign at the beginning of the file names to control the sequence of presentation, the resulting truncated files names will appear for the captions.

Each image is displayed for a pre-determined default period. In one enablement, the default display time is 5 seconds. If the default period allows sufficient time for the next image to be sized dynamically, it will be displayed immediately as the default period for the preceding image terminates, thereby creating a seamless viewing experience in which the background image template does not repeatedly appear without a displayed image in between discrete displays of images. By default, the slide show presentation continues to display the images in a loop (when the last image file in the ordered sequence of presentation has been displayed, the entire ordered sequence is displayed again, beginning with the first image file) until the software execution terminates.

The automatic slide show presentation ends when the user terminates the software execution by depressing a designated key on a keyboard or clicking a mouse to activate a designated GUI control displayed on the computer monitor or other transient display device. For simplicity, the flowchart of FIG. 19 only presents the case of a basic, automatic display of the slide show presentation, and does not reflect the use of all possible keyboard or mouse-activated GUI controls for managing and modifying the slide show presentation in real time, e.g., controls to pause, advance to, or back LIP to an image within the ordered sequence of presentation. All such optional user controls may be made to activate through either a keyboard or mouse.

One such control can be a mouse-activated GUI control for allowing the user to toggle back and forth between a display of the images in the foreground of the background image template and an expanded display of images in full-screen size on the computer monitor or other transient display device without displaying contemporaneously the background image template. In this full-screen mode, a border of a pre-determined number of pixels can be made to appear around the photograph at the longest axis of the image—horizontal or vertical—so that the photograph remains framed within the boundaries of the maximum display area of the computer monitor or other transient display device. Mouse controls involve using the mouse to point to an object on the computer monitor or other transient display device and clicking a designated button. A mouse can have more than one button.

Keyboard-activated controls can be effectuated through the use of a single key or through key combinations. In one enablement of the invention, a user may simultaneously depress an Alt key and a Tab key during a slide show presentation to reduce the dimensions of a slide show presentation as displayed within the display area of the computer monitor or other transient display device, or simultaneously depress a Alt key and a Print Screen key to display only the active window of a slide show presentation.

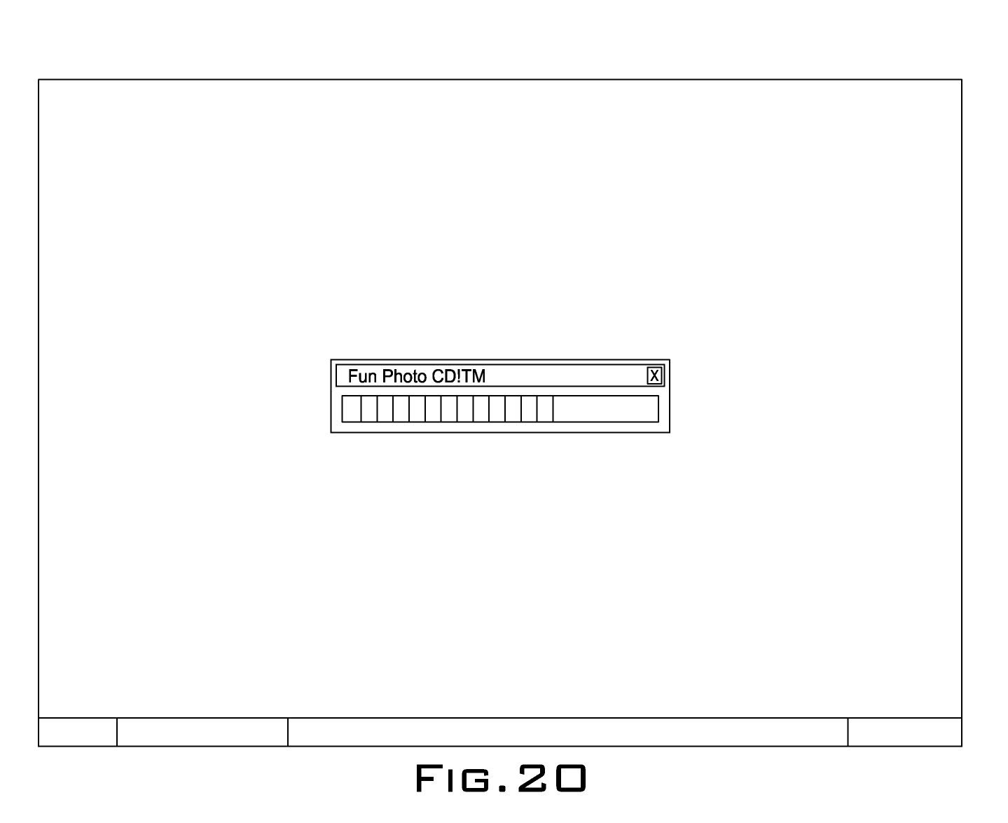

The series of screenshots presented in FIG. 20 through FIG. 27 reflect examples of what a user typically might see while using the removable computer-readable medium to view a transient themed digital multimedia slide show presentation using a computer system for playback. Some of the possible mouse-activated, GUI-based controls are illustrated therein.

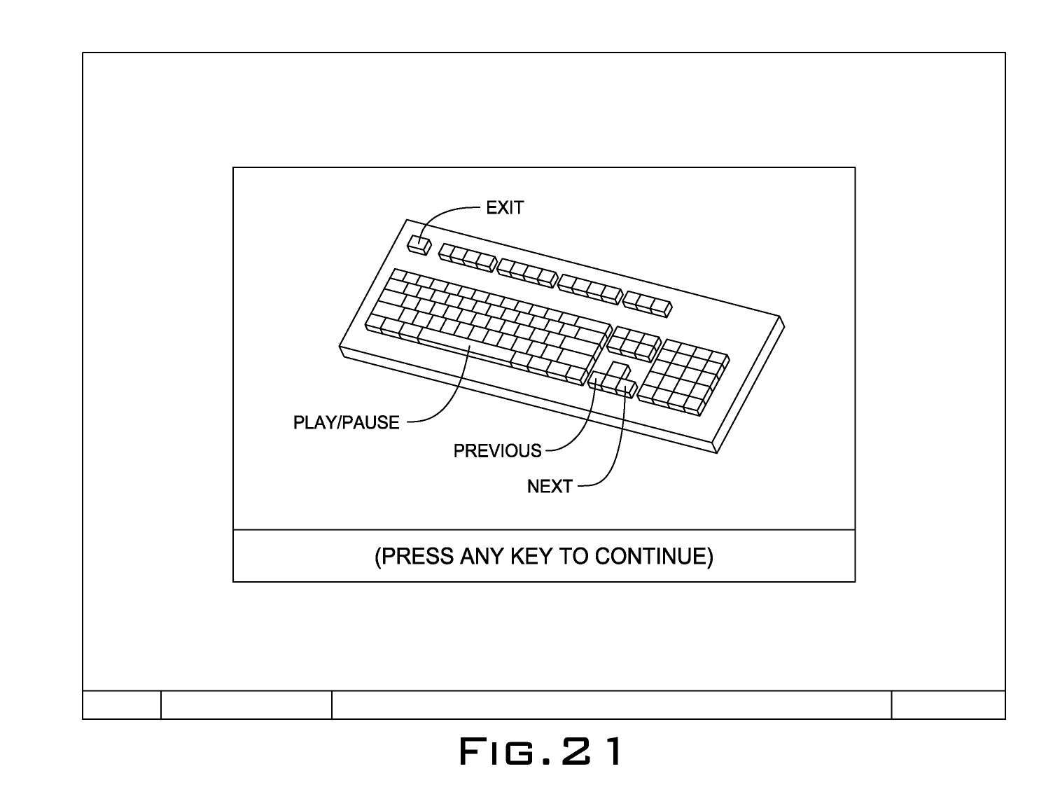

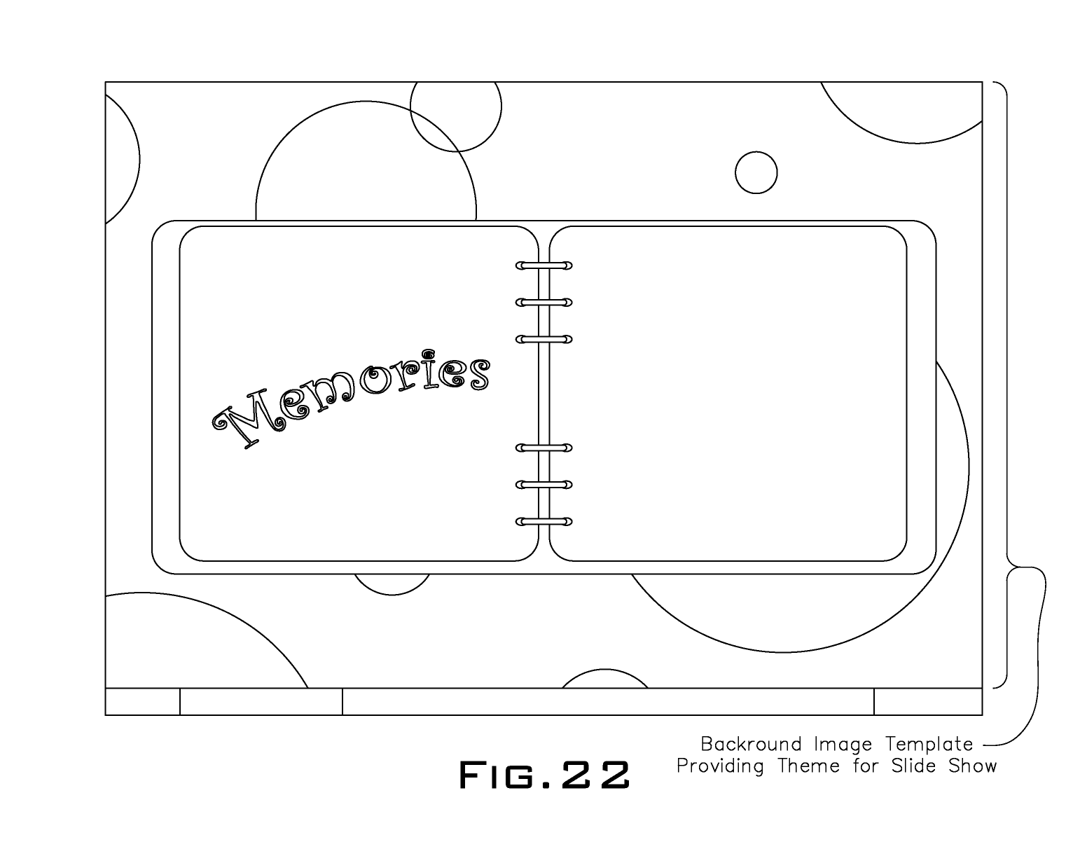

FIG. 20 shows a user screen as the executable completes loading and prepares to begin displaying the multimedia digital slide show presentation. FIG. 21 shows a user screen as the executable completes loading and prepares to begin displaying the multimedia digital slide show presentation. FIG. 22 shows the initial display of a pre-determined background image template, before any images are displayed.

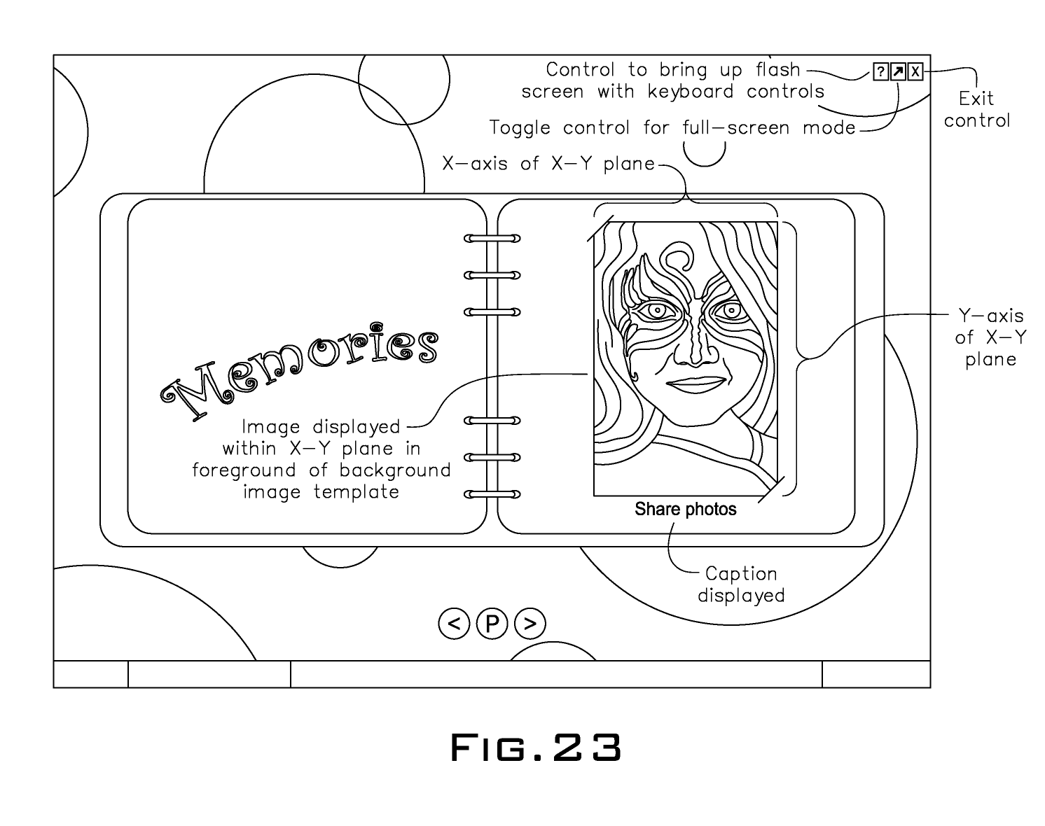

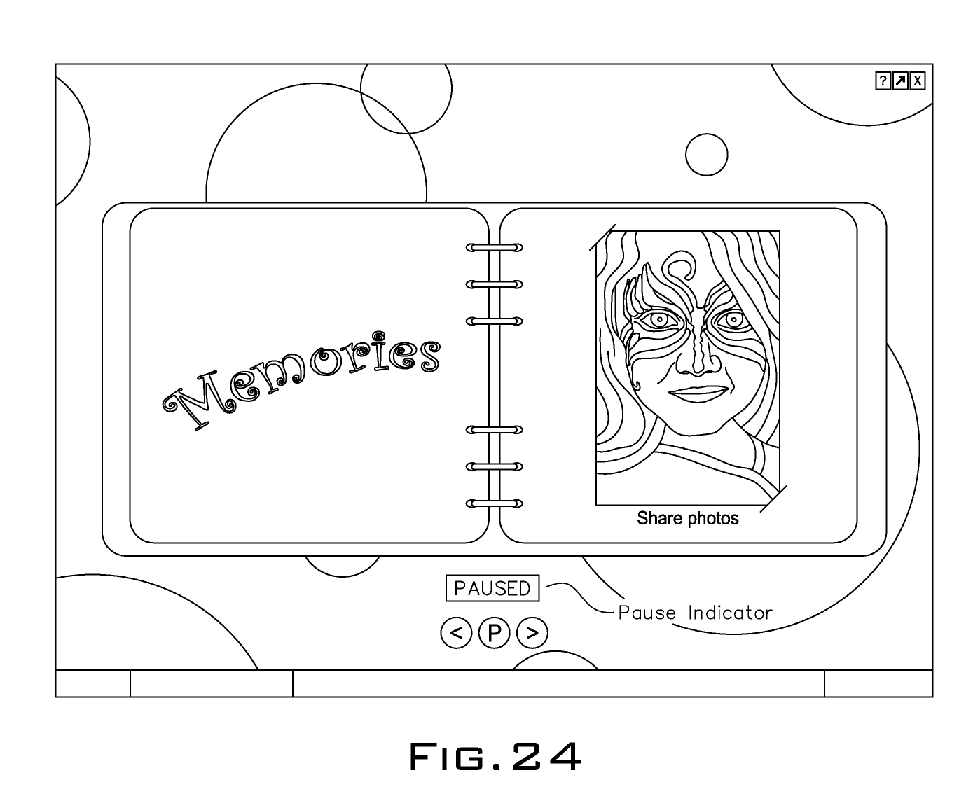

FIG. 23 shows a first image from the image files in an ordered sequence of presentation as displayed in the foreground of a background image template within a designed X-Y plane located within the display area of the template, as well as some graphically presented controls for the display of the presentation. FIG. 24 illustrates a pause indicator displayed following activation of a pause button control pausing the presentation on the first image.

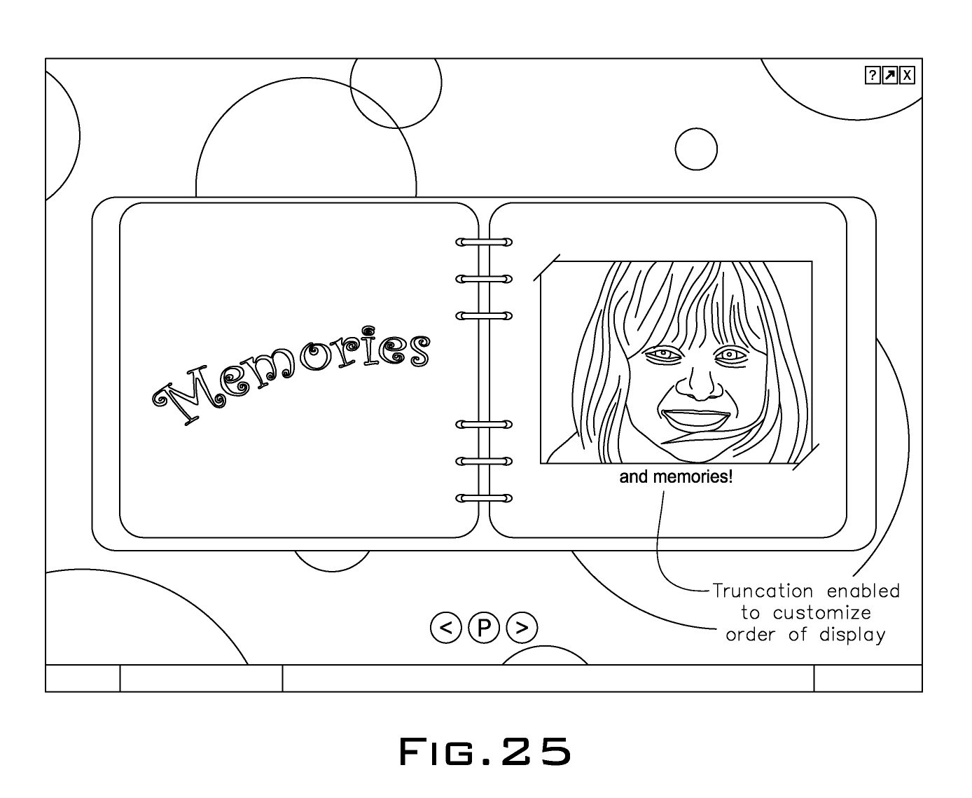

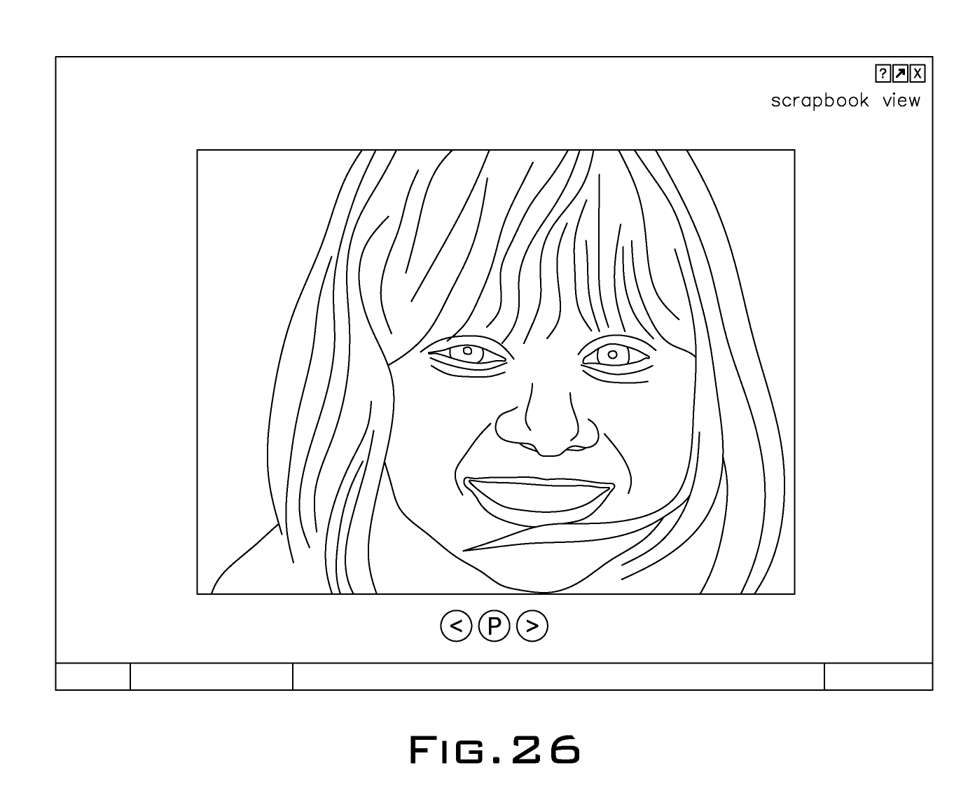

FIG. 25 reflects a second image displayed within the same template following release of the pause button control. FIG. 26 shows a full-frame version of the second image displayed after a toggle control has been activated.

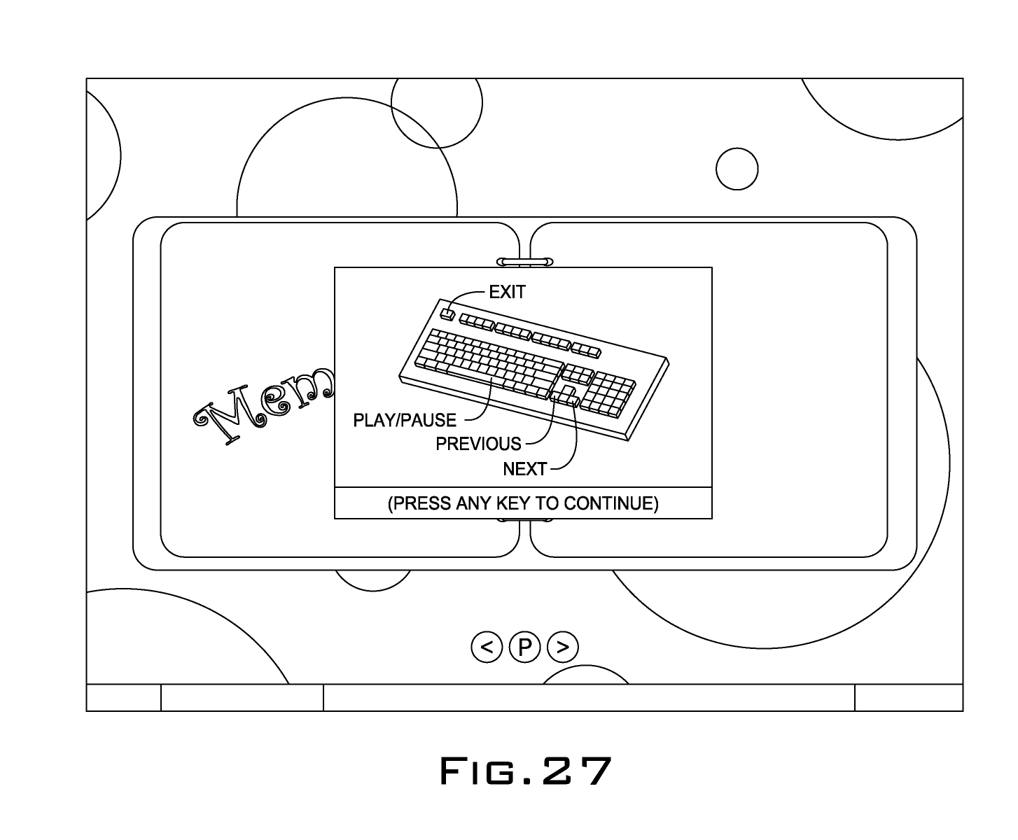

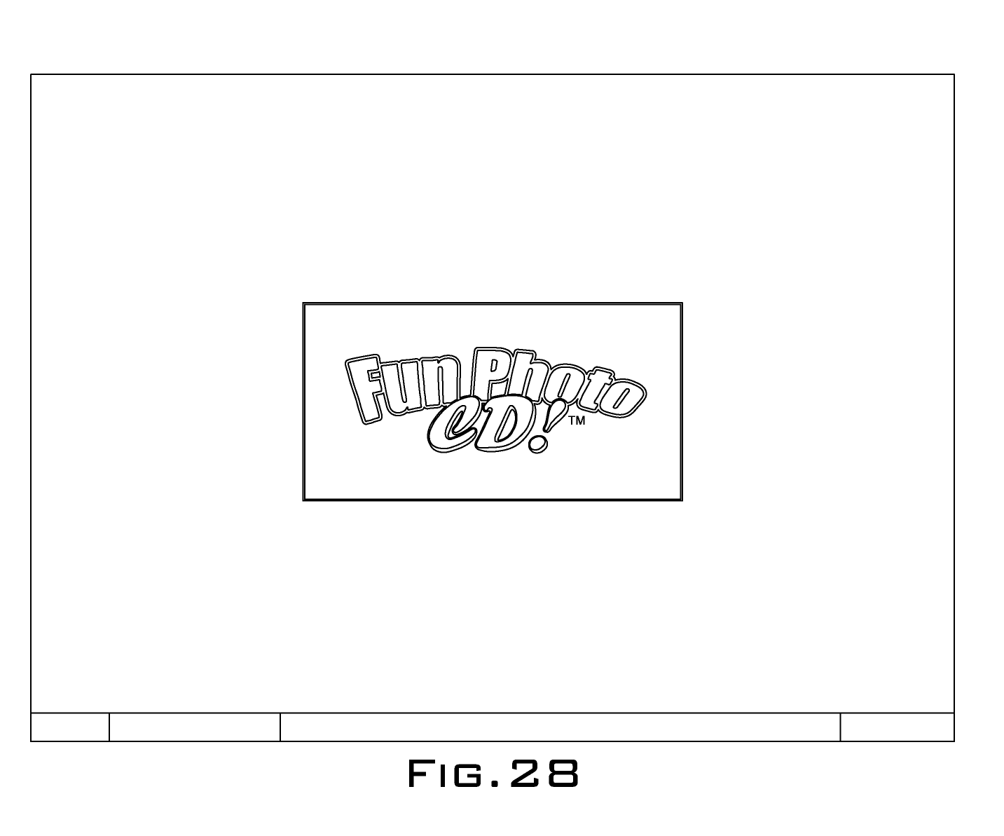

FIG. 27 reflects what the user might see following activation of an information display control. FIG. 28 illustrates a splash screen a user might see following activation of an exit control.

1. A removable computer-readable medium having software that is automatically executed by a computer without the need for intervention by a user when the removable computer-readable medium is inserted into a removable media drive accessible to the computer, causing the computer to perform a method for creating and displaying, dynamically and automatically, in real time, a transient themed digital multimedia slide show presentation from image files and audio files stored on said removable computer-readable medium, comprising the steps of:
searching for all image files on said removable computer-readable medium; and
if at least one image file is found on said removable computer-readable medium, determining an ordered sequence for presentation of the one or more image files found on the removable computer-readable based on pre-determined criteria; and
detecting the resolution of a transient display device attached to the computer; and
sizing a static bitmap of a pre-determined background image template to fill the maximum display area of said transient display device based on the detected resolution of said transient display device; and
displaying said pre-determined background image template on said transient display device; and
beginning with the first image file in the ordered sequence for presentation, and continuing in succession with each subsequent image file in the ordered sequence for presentation, sizing the image from each image file to appear within a designated X-Y plane located within said pre-determined background image template; and
beginning with the first image file in the ordered sequence for presentation, and continuing in succession with each subsequent image file in the ordered sequence for presentation, displaying on said transient display device the sized image within the boundaries of said X-Y plane and in the foreground of the pre-determined background image template for a pre-determined period of time sufficient to allow the computer to size the image from the next image file in the ordered sequence for presentation prior to its display.

2. The removable computer-readable medium and software recited in claim 1, wherein the removable computer-readable medium is a compact disc (CD).

3. The removable computer-readable medium and software recited in claim 2, wherein the removable computer-readable medium is a shaped CD with a capacity of no more than 50 megabytes.

4. The removable computer-readable medium and software recited in claim 3, wherein the removable computer-readable medium is a hockey-rink shaped CD.

5. The removable computer-readable medium and software recited in claim 1, wherein the removable computer-readable medium is a digital video disc (DVD).

6. The removable computer-readable medium and software recited in claim 1, in which the software further causes the computer to execute the step of displaying on a transient display device within a graphical user interface (GUI) interactive information and instructions for preparing said removable computer-readable medium to create and display, dynamically and automatically in real time, a transient themed digital multimedia slide show presentation, if no image file is found on said removable computer-readable medium.

7. The removable computer-readable medium and software recited in claim 1, wherein the software further causes the computer, in advance of searching for all image files on the removable computer-readable medium, to verify certain pre-determined categories of information regarding the removable computer-readable medium.

8. The removable computer-readable medium and software recited in claim 7, wherein the software further causes the computer to verify the presence of the removable computer-readable medium.

9. The removable computer-readable medium and software recited in claim 7, wherein the software further causes the computer to verify the presence on said removable computer-readable medium of a file with a given file name or other means of file identification.

10. The removable computer-readable medium and software recited in claim 7, wherein the software further causes the computer to verify that a maximum of 50 megabytes of data has is stored on the removable computer-readable medium.

11. The removable computer-readable medium and software recited in claim 1, wherein the software further causes the computer to determine the ordered sequence for presentation of the one or more image files found based on an alpha-numeric ordering of the file names of the image files.

12. The removable computer-readable medium and software recited in claim 11, wherein the software further causes the computer to display the file name of the image file while the image for that image file is being displayed if a pre-determined non-alpha-numeric character is appended to the end of the file name for the image file.

13. The removable computer-readable medium and software recited in claim 11, wherein the software further causes the computer to display the file name of the image file while the image for that image file is being displayed, less a pre-determined number of the first characters in the file name, if a pre-determined non-alpha-numeric character is appended to the beginning of the file name for the image file.

14. The removable computer-readable medium and software recited in claim 1, in which the software further causes the computer by default to continue to display the images from the image files in the ordered sequence for presentation in a loop unless the display is paused or reversed temporarily by the user or the software execution terminates.

15. The removable computer-readable medium and software recited in claim 1, wherein the software further causes the computer, after finding least one image file on said removable computer-readable medium, but in advance of determining an ordered sequence for presentation of the one or more image files found, to search said removable computer-readable medium for all audio files, and upon finding at least one audio file, to determine an ordered sequence for playing the one or more audio files found, and beginning when the template is first displayed, to play the audio files in the ordered sequence for playing through one or more audio output devices attached to the computer.

16. The removable computer-readable medium and software recited in claim 15, wherein the software determines the ordered sequence for playing the one or more audio files found based on an alpha-numeric ordering of the file names of the audio files.

17. The removable computer-readable medium and software recited in claim 16, wherein the software causes only the first audio file in the ordered sequence for playing.

18. The removable computer-readable medium and software recited in claim 16, wherein the software further causes the computer to play repeatedly in a loop the first audio file in the ordered sequence for playing when a pre-determined non-alpha-numeric character is appended to the name of the first audio file.

19. The removable computer-readable medium and software recited in claim 1, wherein the software causes the computer, in advance of displaying the background image template, to display for the user an illustration of certain keyboard-based user controls for managing the display of images.

20. The removable computer-readable medium and software recited in claim 19, wherein the software causes the computer, following the display of the illustration of the keyboard-based user controls, to allow the user to initiate the display of the background image template and images manually by depressing any key on a keyboard attached to the computer.

21. The removable computer-readable medium and software recited in claim 1, wherein the software causes the computer to display by default each image for a pre-determined time of five seconds before advancing to the next image in the ordered sequence of presentation.

22. The removable computer-readable medium and software recited in claim 1, wherein the software causes the computer to display within in a graphical user interface (GUI) one or more controls allowing the user to manage with a mouse attached to the computer the display of the images from the image files.

23. The removable computer-readable medium and software recited in claim 22, wherein one of the controls displayed allows a user to pause the sequential display of images from the image files in the ordered sequence of presentation and cause any currently displayed image to display indefinitely.

24. The removable computer-readable medium and software recited in claim 22, wherein one of the controls displayed allows a user to advance the display of an image from a subsequent image file in the ordered sequence of presentation.

25. The removable computer-readable medium and software recited in claim 22, wherein one of the controls displayed allows a user to cause to be displayed again a previously displayed image from an earlier image file in the ordered sequence of presentation.

26. The removable computer-readable medium and software recited in claim 22, wherein one of the controls displayed allows a user to toggle back and forth between a display of an image within the X-Y plane located within the pre-determined background image template and a display of said image that fills the entire viewing area of the transient display device and obscures entirely the pre-determined background image template.

27. The removable computer-readable medium and software recited in claim 1, wherein the software causes the computer to display a menu of controls within a graphical user interface (GUI) when a user right-clicks a two-button mouse attached to the computer.

28. The removable computer-readable medium and software recited in claim 27, wherein one of the controls displayed in the menu allows a user to execute with the mouse an internet browser on the computer and cause the browser to display a pre-determined World Wide Web site.

29. The removable computer-readable medium and software recited in claim 27, wherein one of the controls displayed in the menu allows a user to initiate with the mouse a display of certain pre-determined information.

30. The removable computer-readable medium and software recited in claim 27, wherein one of the controls displayed in the menu allows a user to terminate execution of the software with the mouse.

31. A computer system for preparing, modifying, and using a removable computer-readable medium that creates and displays, dynamically and automatically, in real time, a transient themed digital multimedia slide show presentation from image files and audio files stored on said removable computer-readable medium, comprising:
a computer with a processor, memory, an operating environment with a graphical user interface (GUI), a keyboard, a mouse, a transient display device, an audio output device, and a non-volatile memory storage device on which one or more image files and zero or more audio files are stored;
a media drive capable of accepting, reading, and writing to the removable computer-readable medium described in claims 1 through 30 and which is accessible to and can be used by said computer;
the removable computer-readable medium described in claims 1 through 30; and
additional computer software as may be necessary to effectuate the storage of image files and audio files on said removable computer-readable medium.

32. A computer-implemented method for preparing a removable computer-readable medium to create and display, dynamically and automatically, in real time, a transient themed digital multimedia slide show presentation from image files and audio files stored on said removable computer-readable medium, comprising the steps of:
inserting into the removable media drive of a computer system, as recited in claim 31, the removable computer-readable medium recited in claims 1 through 30 on which removable computer-readable medium have not yet been stored any image files or audio files;
transferring from the non-volatile memory storage of the computer to the removable computer-readable medium one or more user-selected image files and zero or more user-selected audio files by dragging and dropping said files from said non-volatile memory storage onto the removable computer-readable medium within a graphical user interface (GUI) on said computer using a mouse attached to said computer; and
effectuating the storage of any said image files and any said audio files to the removable computer-readable medium using, as necessary, additional software.

33. The computer-implemented method of claim 32, wherein the removable computer-readable medium is a hockey-rink shaped CD, and storage of any said image files and any said audio files is effectuated by burning the files to the hockey-rink shaped CD using CD burning software.

34. The computer-implemented method of claim 33, wherein any said image files and any said audio files are stored on the hockey-rink shaped CD by using the CD burning software to perform an open burn, thereby allowing additional image files and additional audio files to be burned to the hockey-rink shaped CD at a later time.

35. A computer-implemented method for modifying a removable computer-readable medium that creates and displays, dynamically and automatically, in real time, a transient themed digital multimedia slide show presentation from image files and audio files stored on said removable computer-readable medium, comprising the steps of:
inserting into the removable media drive of a computer system, as recited in claim 31, the removable computer-readable medium recited in claims 1 through 30, on which removable computer-readable medium have been stored already one or more image files and zero or more audio files;
transferring from the non-volatile memory storage of the computer to the removable computer-readable medium one or more user-selected new image files and zero or more user-selected new audio files by dragging and dropping said new image files and said new audio files from said non-volatile memory storage onto the removable computer-readable medium within a graphical user interface (GUI) on said computer using a mouse attached to said computer; and
effectuating the storage of any said new image files and any said new audio files to the removable computer-readable medium using, as necessary, additional software.

36. The computer-implemented method of claim 35, wherein the removable computer-readable medium is a hockey-rink shaped CD, and storage of any said new image files and any said new audio files is effectuated by burning the files to the hockey-rink CD using CD burning software.

37. The computer-implemented method of claim 36, wherein any said new image files and any said new audio files are stored on the hockey-rink shaped CD by using the CD burning software to perform an open burn, thereby allowing further new image files and further new audio files to be burned to the hockey-rink shaped CD at a later time.
